(19) United States
(12) Patent Application Publication
(10) Pub. No.: US 2004/0148243 A1
(43) Pub. Date: Jul. 29, 2004

(54) System and method for non-linear negotiation

(76) Inventor: Michael Maruin Rosenblatt, San Jose, CA (US)

Correspondence Address: MICHAEL M. ROSENBLATT, 8082 WINERY COURT, SAN JOSE, CA, 95135-1450, US

(21) Appl. No.: 10/352,440

(22) Filed: Jan. 28, 2003

(51) Int. Cl. G06F 17/60

(52) U.S. Cl. 705/37

(57) ABSTRACT

Computer-based system and method allows one or more users to select and assign discretionary numerical, mathematical and hierarchical values to disparate, unconnected preferences or data. Auditors may be selected by users. Users obtain textual information about negotiation methodology and behavioral modification. Users and auditors may use collective bargaining to establish new preferences, with agreed upon numerical, mathematical and hierarchical values. Those are transferred to Personal Data Assistant or paper for action or evaluation. Projects are evaluated periodically for verification of compliance and statistical reports generated. Auditors may pursue real-time monitoring and investigations of those projects. Multiple auditors can overlap investigations to improve reliability. Users and auditors may by discretion substitute for each other's position. The system is a circular feedback loop for every user and auditor.

### BACKGROUND OF THE INVENTION

### Field of the Invention

The present invention relates generally to negotiations and more particularly to a system and method of non-linear negation.

Previous methods of negotiation and agreement include, but are not limited to:

1. To do lists

2. Calendar based embodiments of tasks, including computer programs with same

3. Discussions offered by and for salespeople using manipulation psychology to enhance sales and profits

4. Software to encourage the attainment of agreements and reaching common goals

5. Lawyer assisted negotiation

6. Collective bargaining with federally supervised negotiations

7. Professional arbitration

8. Court induced and forced compliance

9. Attainment of agreements and contracts without legal assistance

10. Purchased agreements and contracts available in stationary stores, outlets and the Internet

11. Marriage and performance contracts

12. Large construction and projects software with task lists

13. Court system

14. Behavioral therapy and counseling

15. Various empirical data management methods without concomitant preference development, collective bargaining and performance audits.

16. Various Federal and state alternative resolution processes

17. Roberts Rules of Order, Henry M. Robert, III, William J. Evans (Editor), Daniel H. Honemann (Editor), Thomas J. Balch (Editor) Sarah Corbin Robert, Henry M. Robert III, General Henry M. Robert, Publisher, Perseus Publishing, 10^{th} Edition Nov. 14, 2000, ISBN 0738203076

18. The Standard Code of Parliamentary Procedure, 4^{th} Edition, by American Institute of Parliamentarians, Alice Sturgis, Publisher: McGraw-Hill Trade; Dec. 7, 2000 ISBN: 0071365133

19. Ernest M. Thiessen reported in 1994 (Thiessen, Feb. 27, 1996, U.S. Pat. No. 5,495,412, Assignee ICAN Systems, Inc. Application # 275,521, filed Jul. 15, 1994) that . . . “recent developments in modeling negotiation processes is motivating work in the use of computer-based analyses of negotiation problems. The complexity of negotiation problems is a challenge.” The above comments are made in his description: “Computer-based method and apparatus for interactive computer-assisted negotiations.”

20. Thiessen, Ernest M. et al. “Computer Assisted Negotiation of Muliti-objective Water Resources Conflicts, Water Resources Bulletin, vol. 28, No 1 pp 163-167, Feb. 1992

21. Frankel, Kenneth 1998, U.S. Pat. No. 5,718,247 Feb. 17, 1998 Application # 655632, Filed May 30,1996 “Apparatus and process for interactive psychotherapy” Kenneth Frankel describes in his abstract: “A process and apparatus for interactive psychotherapy in which information produced during a patient's therapy is categorized according to data type. The information is then stored to a series of interconnected databases stored in a computer.”

22. Joao, Raymond Anthony 1999, U.S. Pat. No. 5,961,332, Filed Feb. 13, 1996 “Apparatus for processing psychological data and method of use thereof,” Raymond Joao describes in his abstract: “An improvement to an apparatus for processing psychological data, said apparatus comprising means for processing data indicative of at least one of an individual's psychological condition, psychological states, concomitant physiological states and states of dysfunction . . . ”

23. Luciano, Joanne Sylvia 2000, U.S. Pat. No. 6,317,731, Filed May 11, 2000, Application # 568762) “Method for predicting the therapeutic outcome of treatment,” Joanne S. Luciano describes her abstract as: “A method useful for facilitating choosing a treatment or treatment regime and for predicting outcome of a treatment for a disorder which is diagnosed and monitored by a physician or other appropriately trained individual.”

24. Lonski, Michael, 2002, U.S. Pat. No. 6,338,039, Assignee: Lonski, Michael U.S. Pat. No. 6,338,039, Application # 358168) “Method for automated collection of psychotherapy patient information and generating reports and treatment plans” Michael Lonski reports in his abstract: “The method and apparatus automatedly generates various reports for a psychotherapy provider. These reports include Treatment Plans, progress notes, scheduling reports and billing reports.”

25. Bair, et al, Aug. 22, 2000, Assignee: The Psychological Corporation, U.S. Pat. No. 6,108,665, Filed Jul. 3, 1997 “System and method for optimizing behavioral health care collection.” Steven L. Bair describes in his abstract: “A system and method for collecting behavioral health care data for a patient include a mechanism for creating an evaluation instrument from a database of questions having linked answers thereto.”

26. Peter, Douglas, Mar. 21, 2000, Assignee Salus Media Inc. U.S. Pat. No. 6,039,688 filed Oct. 31, 1997 “Therapeutic Behavioral Modification Program, Compliance Monitoring and Feedback System.” Peter Douglas describes in his abstract: “A therapeutic behavioral modification program, compliance monitoring and feedback system includes a server based relational database and one or more microprocessors electronically coupled to the server.”

27. Bro, William L. Jun. 19, 2001, Filed Mar. 4, 1998, Application # 034271, U.S. Pat. No. 6,249,809 “Automated and interactive telecommunications system.” William Bro describes in his abstract: “An automated and interactive system that allows a physician, counselor, teacher, employer or trainer to produce and send information, messages and/or questions to, or to elicit responses or information from, a client, patient, employee or student.”

One of the main problems with negotiation, behavior modification and verification methodologies is that they are not codified for specific requirements. They are useful to the extent that participants make the correct selection. Often the people who use them don't know how to select the appropriate models for their own needs. The key is to match method with purpose. Each of the prior methods has shortcomings depending on the needs of consumers. More specifically, there are very poor or absent options for non-linear negotiation and non-linear data management. Despite the multiplicity of negotiation methods and technologies, our society has apparently failed to find adequate solutions to the problems of communication, consensus building and task verification.

Hidden agendas dominate. Cumbersome compliance rules are written into contracts and agreements that do more to obfuscate and complicate than clarify. They include detailed penalty clauses and a myriad of other negative features. It's difficult to protect participants from the effects of unsatisfactory compliance. There is constant arguing and disagreement even between family members. Entertainment media make us laugh at these foibles; but we are all paying a price. We are not necessarily good at communicating; and when we try, others are not really listening.

If we knew that compliance would be investigated and vigorously monitored on an ongoing basis we may view negotiation differently. Contracts and agreements could be much shorter. Negative features designed to protect us could either be left out or covered with only a few comments. The essence of contracts and agreements is behavior modification. Each party desires to modify the behavior of the other side to reach a goal, which may or may not be what the other side really wants. Attempts to bring computers into the system have generated more complexity.

We hire lawyers to defend our legal interests and help us negotiate contracts. This is as it should be because we need them to guide us through the thicket of the law. But even lawyer's tools have limitations. These limitations most commonly occur in the maintenance and verification of existing contracts.

There are two aspects of this issue: Negotiation and agreement, and resolution of disagreements after contract failure. People have been trying to solve disagreements for millennia. The Talmud has an adjudication system overseen by esteemed Rabbis. Contract disputes in modern times are overseen by our legal system, which has checks and balances in the courts, through an adversarial format. Its efficiency is arguable. The courts are over-run with nuisance suits. Many unworthy actions clog the system, thereby preventing the solution of real and pressing disputes in a timely manner. The expense is legendary. Tort disagreements can take years to clear; and even after they are, the aggrieved might have to enter an entirely new legal action to obtain redress. Worse, it is so clogged that necessary criminal actions might have to be put on hold to make room for everything else.

Disputes over property and behavior can result in violence. Family law practitioners are never quite sure how a party to divorce is going to react in that painful process. Violence and threats can make that practice very stressful, and periodically, violent deaths occur.

Most people give no real thought to negotiation policy. They strut out into an undefined, nebulous field with little or no direction. Even our complex legal system has not really codified negotiation patterns for specific configurations. The typical contract provides for agreement and designation of the events that will occur if one or more party fails the demands. Most people don't carry their contract with them daily. They have a rough idea what is in it and try to follow it in good faith. In many cases the contract itself is sufficient to guide the signatories, but not always. Neither are the courts sufficient.

A perfect example of this inadequacy is when it is necessary for on-going real-time monitoring. Using the courts is cumbersome and unrealistic. Judges detest day-to-day management of contracts feeling correctly, that this is not their responsibility. It just deflects the courts away from other pressing matters. Even when courts appoint enforcement “commissions,” which is what they usually do, valuable time is lost. Expenses are generated and everything involved ends up diluting the courts' effectiveness. Contracts should be monitored by the people involved with them; or they should hire people who will. If users wish to use the courts to enforce them later, fine. That is the courts' real utility.

In Constitutional Democracies we are uncomfortable with class distinctions. We prefer not to describe household workers as servants, preferring any other euphemism. There is no such thing as a course in “negotiation” in high schools. Every first year law student is taught that the Courts are a great equalizer. That disagrees with the assumption that the rich and powerful always tilt the scale of negotiation to their side. When software magnate Bill Gates was sued by the Government for violating monopoly laws, he was forced to go to court and testify, perhaps to be held to public examination and ridicule or worse. This was either a negotiation of equals or the Government still was more powerful.

Courts automatically re-define a negotiation into adversarial status, something that participants might not really want, except for legal counsel. In my opinion what we really need is to learn the basics, categorize negotiations and define the type we are entering in advance. This doesn't mean that negotiators need be experts in Constitutional law or have philosophy degrees. Those professionals are often more interested in strength of argument than consensus.

But it means recognizing power issues for what they are. It is unusual for parties to negotiation to be of equal power, even though it does occasionally occur. Planning and preparation will often level the field. This program will allow both sides to plan and prepare. It will also give them the tools to make sure that their agreements will be executed. That knowledge will empower all participants.

Those few who have negotiation skills often use them for exploitation, perhaps at the expense of others. Then there is the issue of deciding what method of negotiation is most appropriate: Adversarial, co-operative, non-linear, linear, Socratic, etc. Totalitarian societies use nihilism and devaluation of the individual, often permitting no negotiation at all. Democracies base their laws on negotiation and valuing human behavior. This invention sides with democracy. In ordinary human relationships, there exist many opportunities for misunderstanding, exploitation, hidden agendas and arguments, even over such mundane aspects as daily repeated family chores. This can become multiplied to enormous tragedy if one outwardly extrapolates lack of communication and negotiation skills to larger populations.

In the context of the present invention, linear negotiation is referred to as a method of communication where execution of an agreement is the primary goal, and everything else is secondary, including documentation and verification. Non-linear negotiation as a method or system where all of the considerations of agreement, documentation and verification sustain equal value and occur concomitantly throughout the agreement or contract, through the employ of an auditor who has access to the users or parties to the negotiation. There is nothing inherently advantageous to either linear or non-linear negotiation. But in efforts to assure proper and effective communication, it would be very helpful to identify the right method for the planned negotiation in advance.

Before one decides the best method for a particular negotiation, one must first identify a non-linear method and find it. This invention provides for non-linear negotiation. Non-linear methodology has occurred in various agreement and contract negotiations, but they tend to have a sporadic, poorly organized and spotty configuration. Even when documentation and verification addenda are built into a contract, they are frequently an afterthought. In the non-linear configuration of the present invention, training for negotiation, preparation for negotiation, negotiation and verification each has an orderly, defined and fully integrated placing. What makes it unique is that it is a closed circle. A properly constructed non-linear negotiation program would allow any participant to exchange places with any other, whereby the construct transforms itself into a teaching tool. “Substitute” performance of identical tasks are easily scored and compared. Even letter grades are possible.

Linear negotiation is most appropriate when routine monitoring is not necessary or would be prohibitively expensive. An example might be the sale and cash purchase of an automobile. Once the money is paid; the auto is delivered. Verifying delivery is easy; the purchaser is sitting in the car. The buyer might wish to make sure it has the features ordered, but that only takes a few minutes. While parties to the negotiation might bargain for a price that suits each, once the price is agreed and paid, the car is delivered.

Non-linear negotiation is most appropriate when documentation and verification must be applied routinely throughout the life of the contract or agreement. An example is the Israeli/Palestinian War. Negotiations in this venue are useless unless they include routine documentation and verification. Verification has value. Modern biological research has tantalized us with the success of enzyme feedback systems that nature provides for immediate real-time management and repair. Satellite photo-technology improvements led to Soviet/American nuclear disarmament treaties, helping to end the fifty-year plus Cold War. In that case the non-linear aspect was the existence of the improved satellites, which served as the engine of routine compliance monitoring. Other features, like on-site inspections also occurred, but satellite photography started the process of reconciliation. We should not forget the historical context of that conflict. Both countries very nearly entered a nuclear exchange at least once. It is too easy to forget that history; and the contribution that verification has to offer.

The following are some examples of negotiations:

1. The American Criminal Justice System is a Socratic, unequal, non-linear, adversarial, forced negotiation.

2. The purchase of a car if price is that actually quoted on car is an unequal, Co-operative, linear negotiation.

3. The purchase of a car if price is negotiated is an unequal, adversarial, linear negotiation.

4. Israeli and Palestinian negotiations (at present) is an example of unequal, adversarial, linear negotiations.

5. The first Soviet/American Nuclear test ban treaty was an equal, non-linear, adversarial negotiation.

6. The subsequent Soviet/American Nuclear test ban treaty was an equal, non-linear co-operative negotiation.

7. The real estate home purchase in buyer's market is an equal, co-operative, linear negotiation.

8. An abusive home relationship is an unequal, adversarial, linear, forced negotiation.

9. Negotiation of pre-nuptial agreement with a wealthy person is an unequal, co-operative, non-linear negotiation.

10. The use of the present invention with an auditor is either an equal or unequal, but co-operative, non-linear negotiation.

11. The use of the present invention without an auditor is either an equal or unequal, but co-operative, linear negotiation.

12. The use of this invention with Auditor and opposing attorney equal or unequal, adversarial, non-linear negotiation.

There are many reasons to understand negotiation classifications. One example exists when opposing parties are in a grossly unequal situation. The weaker party then understands that there is a need to level the field. Stronger parties (such as Government or large businesses) use written (or at least well known) negotiation policies and tactics. Preparation, understanding their rules, hiring effective counsel, looking for weaknesses in the stronger parties' system can help level the field. An example is Microsoft. This company is known for being a powerful if not unfair adversary. Anyone engaging negotiations with them (except for Government) is at a significant disadvantage.

As soon as you go in to the negotiation, you might inform them that their reputation precedes them: “That they probably will either steal most of your product for their own use without compensation, and/or find a way to avoid signing a contract.” You should try to avoid giving them too much detail about your program; for fear that this will occur. Once they understand that you don't trust them, this helps level the field. Probably you will not come to agreement with them. But at least your product will be safe from their grasp. If they want it enough, they might be willing to accept your terms prior to disclosure, but at least YOU will be in the driver's seat. You can open and close your disclosure like a spigot in a bathtub, letting drops out when it suits you, and not before.

Another reason is exemplified by the California Energy Crisis in 2000-2001. When the California Legislature passed AB 1890 in 1996, deregulating energy, it neglected to understand that this was non-linear. Power consumption and payment is a circular rotating contract. A rotating contract is one that involves periodic expected and unexpected changes in the price of a commodity or service and its availability over the life of the contract. Any non-linear negotiation, without the benefit of adequate auditing and verification can lead to GAMING. Anybody who uses this invention will become aware of this simple fact almost immediately, since it is clearly explained in my program. Unfortunately the legislators and Governor who passed this legislation did not understand this concept, or if they did, ignored its implications. As this document is now written, energy companies have gamed California out of billions of dollars, leaving vital state programs and assistance of needy individuals in ruins. Jobs have been lost in vital sectors and the state's economy will probably take years to recover. There used to be a huge surplus, yet as of this writing, it is gone.

The painful irony is that Government could still have deregulated energy and attempted non-linear negotiation by hiring professional energy auditors to issue periodic reports. This might have prevented or limited gaming. Even a modest understanding of negotiation principles would have helped.

The essence of creating contracts and agreements is valuing and ordering human behaviors. Human behaviors have value. The value to one person may be vastly different from one to another, possibly valued in opposite directions. Inherent in language is the ability to shade and nuance those values to some extent. Actual human presence helps communication, as evidenced by the fact that in-person conversations are more reliable than only telephone use. It would be helpful to have other methods. Describing behaviors as negative and positive numbers in a hierarchical continuum would be clearer to everyone, whether they are present or not. This allows individuals to identify and “own” their own interpretation. When individuals order human behavior and install numbers of value on them, they must concentrate on what is most important to them. This tends to remove hidden agendas and make communication more obvious.

### SUMMARY OF THE INVENTION

A primary advantage of the present invention is to provide a computer-based system and method to allow one or more users to select and assign discretionary numerical, mathematical and hierarchical values to disparate, unconnected preferences or data. Auditors may be selected by the users. Users obtain textual information about negotiation methodology and behavioral modification. Users and auditors may use collective bargaining to establish new preferences, with agreed upon numerical, mathematical and hierarchical values. Those are transferred to Personal Data Assistant or paper for action or evaluation. Projects are evaluated periodically for verification of compliance, and statistical reports generated and auditors may pursue real-time monitoring and investigations of those projects. Multiple auditors can overlap investigations to improve reliability. The system provides a circular feedback loop for every user and auditor.

The present invention provides an integrated, computer-implemented, electronically deliverable method to integrate the following attributes:

1. Identification of numerical values and ordering of hierarchical importance to disparate behaviors and data, based upon the needs of the submitters.

2. Learn new negotiation practice, identify pitfalls, power issues, destructive behavior and classify negotiation types and behavior modification in preparation for deciding the most appropriate.

3. The delivery of those behaviors and/or data to others, or preparing them for personal use. These are called “Wishlists” and contain listed preferences of users.

4. Sitting down to collective bargaining to develop consensus Worksheets for each participant, or developing one's own Worksheet, or in ordering hierarchical data streams, or in discussion with a professional and/or an auditor.

5. Downloading agreed upon Worksheets into Personal Data Assistants or using the screen of the central computer, or paper.

6. Performing the tasks or evaluating the data and recording the real date/time it was done.

7. Uploading that data into the central computer program, by hand or by computerized synchronization of data.

8. Requiring that information be entered into a permanent data base record of date and time that cannot be changed, only added to and accessed for reports.

9. Auditors then document the satisfactory completion of those tasks and view reports, perhaps by using the same Worksheets as participants, or using comment fields of their own.

10. Auditors may present reports based upon their real-time research and/or evaluation of statistical reports generated by the program

11. The program is a closed loop, allowing for continual repetition by both auditors and participants.

12. Auditors can be assigned “overlapping verification” to establish a “circle of reliability.”

13. Auditors are paid according to the time spent on this program, at a pre-negotiated, designated rate.

14. Return to any other place in the program.

In a linear negotiation, steps 1- 8, above, are utilized. In the non-linear, steps 1-14 are utilized.

In accordance with preferred embodiment of the present invention, a system for non-linear negotiation for one or more users comprises an input subsystem for one or more users to input and store preferences, a non-user auditor; inputting and storing for each user relational attributes of each preference and agreed upon by all users and the auditor, a list for each user of the preferences and each preference's relational attribute, and a compliance subsystem for users to indicate whether each preference is completed not completed, or the degree to which it is partially completed on an ongoing basis; whereby the auditor monitors progress of list preferences and can interact with each user as needed.

In accordance with another embodiment of the present invention, a method for non-linear negotiation, behavioral modification, and or data manipulation for users comprises the steps of creating a list of preferences for each user, or data stream for each user, creating lists of preferences and/or a data stream and assigning user designated values to entries, establishing a non-user auditor, agreement by all users and auditor on relational attributes for each preference or entry from the data stream, indicating for each user whether each preference or item in data stream is evaluated or completed, not evaluated or completed, or the degree to which the preference or data stream items are partially completed on an ongoing basis; and creating detailed reports based upon the user's pre-designated algorithms or mathematical choices, monitoring progress of list preference by the auditor and interacting with any user on an as needed basis.

In accordance with another embodiment of the present invention, a system for linear negotiation for one or more users comprises subsystem for one or more users to input and store preferences, inputting and storing for each user relational attributes of each preference agreed upon by all users, a list for each user of the preferences and each preference's relational attribute, and a subsystem for users to indicate whether each preference is completed not completed, or the degree to which it is partially completed on an ongoing basis.

Other objects and advantages of the present invention will become apparent from the following descriptions, taken in connection with the accompanying drawings, wherein, by way of illustration and example, an embodiment of the present invention is disclosed. In accordance with a preferred embodiment of the invention, there is disclosed:

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a flow chart of the operations that comprise the method of non-linear negotiation in accordance with a preferred embodiment of the present invention.

FIG. 2 is a chart that comprises the reports available in the present invention.

FIG. 3 comprises the appearance of the Palm Data Device Screen as implemented in the preferred embodiment of the present invention.

FIG. 4 comprises the Auditor's Registration Module as may be implemented in the present invention.

FIG. 5 comprises the Auditor's PDA Comment screen as may be implemented in the present invention.

The following components are assigned the following reference numerals in the drawings:

Licensing and disclaimers 21

Data Base Module 25

“What do you want” 26

Sub-choice Categories, 30

Value Assignment Module, 35

Open File Name, 37

Worksheet Creation Module, 45

List Items in Order from Most Important at Top to least at bottom 50

Upload Finished Worksheets back into center Computer (becomes permanent and unchangeable) 59

REPORT MODULE 65

Auditor's Registration Module 75

Auditor's prepare their own Worksheets for Audit 82

Auditor's Feedback loop 84

Additional Auditor's Feedback loop 85

Additional Auditor's Feedback loop 86

Auditor's Enter prepared Worksheet Files for Auditing completion 87

Date and Time Recorded 89

Comment Section of PDA Screen 90

AUDITOR's PRINTED REPORTS 95

“Are You Finished Y N,” 98

Additional Auditor's Feedback loop 100

Download to PDA 105

Hand Entry Upload 115

User's Feedback loop 120

Additional “Are you Finished Y N” Auditor's PDA Comment Screen 125

### DESCRIPTIONS OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

In operation of one embodiment of the present invention of non-linear negotiation,

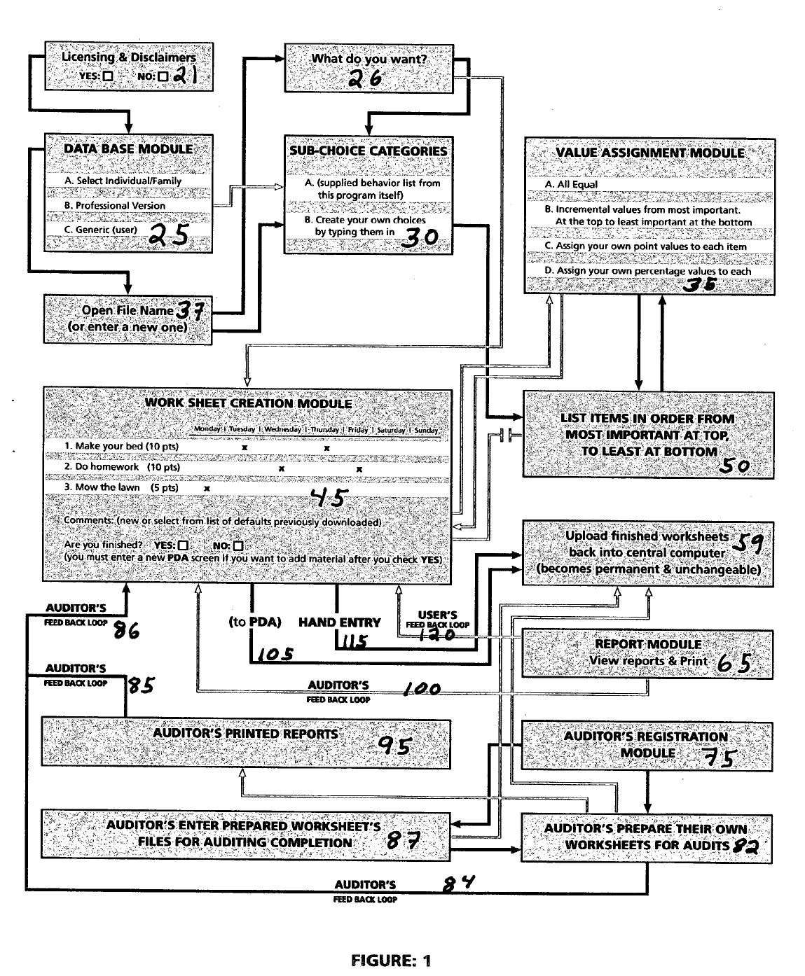

1. The user enters the licensing and disclosure module, (FIG. 1, box 21) and answers Y or N to accepting the licensing agreement

2. If the user accepts the licensing agreement they will proceed to the Data Base Module, (FIG. 1, box 25), which gives them the option of selecting choice A, B or C.

3. Choice A will refer them to the Individual/Family version, Choice B will refer them to the Professional Version and Choice C will refer them to the Generic version

4. If they select the Individual/Family version they will proceed to box 37, FIG. 1, which allows them to “Open a File.” Or enter a new one.

5. The B choice (on FIG. 1, box 25) will allow them to enter box 37 FIG. 1 to open a file name or enter a new one.

6. The C choice (on FIG. 1, box 25) will allow them to enter box 37 FIG. 1 to open a new file name or enter a new one.

7. If they enter a new file name they will be given an opportunity to register it. If they select an existing file name they will have the opportunity to enter box 26, FIG. 1, asking them “What do you want?”

8. If they enter a new name, after registering it, they will be given the option of going to box 26, FIG. 1, “What do you want?”

9. After they go to box 26, FIG. 1 they will have the opportunity to enter box 30, FIG. 1, which has two choices: Choice A: A list of supplied behaviors and wishes covering a wide range of subjects, and choice B, which gives them the opportunity to “Create your own choices.”

10. If they select choice A, (refer to FIG. 1, box 30), they will see a long list of behaviors and wishes from which to choose from. They can select them and they will appear in box 50, also called the Wishlist, FIG. 1, entitled: “List items in order from most important at top to least at bottom.” They will also have the option during this process to “create their own.”

11. If they select choice B in box 30, FIG. 1, they will go directly to box 50, also called the Wishlist, FIG. 1 to “List items in order from most important at top to least at bottom.”

12. After this list is created in box 50, (refer to FIG. 1) also called the Wishlist, FIG. 1, they will have the option to assign values to those data or lists, by going to the VALUE ASSIGNMENT MODULE, box 35, FIG. 1, which allows them 4 choices: A. All equal, B, Incremental values from most important at the top to least important at the bottom, C Assign your own point values to each item and D, Assign your own percentage values to each.”

If they select A choice (box 35, FIG. 1) they will automatically see all values equal. If they select B choice (box 35, FIG. 1) the most important item will be at the top and then incrementally from there to the bottom, depending on the number of objects stored on the list, and choice C (box 35, FIG. 1) they will be given the opportunity to install point values to each item or data, and Option D (box 35, FIG. 1), will be allowed to assign percentage values to each item or data. The user will have to be correct in their numerical entries on option D, or the program will give them an error message and ask them to recalculate their choices.

13. The items or data are stored in box 50, FIG. 1, whether or not they have associated hierarchical values will constitute their “Wishlist.”

When the present invention is used as a collective bargaining, behavioral modification and data-list management system, the follow operation may be employed in a preferred embodiment.

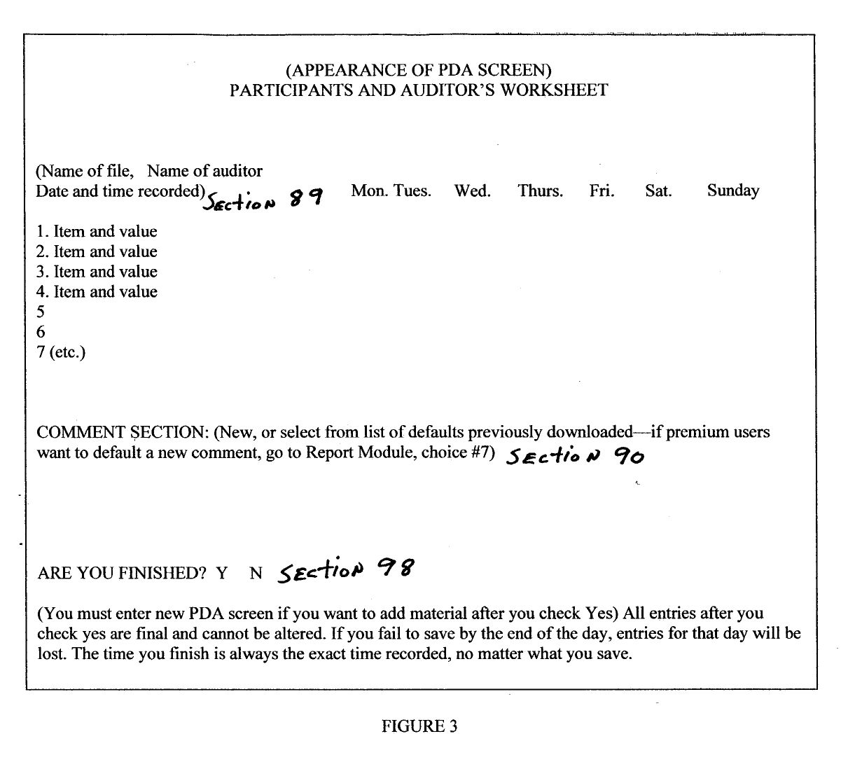

1. The items stored in box 50, also called the Wishlist, FIG. 1 will constitute lists for users to deliver to others for collective bargaining, for personal use to deliver to box 45, FIG. 1 and FIG. 3, for the development of “Worksheets” and/or for delivery to box 45, FIG. 1 and FIG. 3 for data management.

2. If the invention is used for Collective Bargaining, users will have the opportunity to create new preferences on Worksheets for each individual and auditors (box 45, FIG. 1 and FIG. 3).

3. If the invention is used for Behavioral Modification, users will have the opportunity to create new preferences on Worksheets for themselves or others (box 45, FIG. 1 and FIG. 3)

4. If the invention is used for Data Management, users will have the opportunity to create new preferences on Worksheets for themselves or others (box 45, FIG. 1 and FIG. 3).

5. Users presenting lists (refer to box 45, FIG. 1 and FIG. 3) will have the option to return to box 35 (VALUE ASSIGNMENT MODULE) to create and identify new values to those lists.

6. They will do so as follows: If they select A choice (box 35, FIG. 1) they will automatically see all values equal. If they select B choice (box 35, FIG. 1) the most important item will be at the top and then incrementally from there to the bottom, depending on the number of objects stored on the list, and choice C (box 35, FIG. 1) they will be given the opportunity to install point values to each item or data, and Option D (box 35, FIG. 1), will be allowed to assign percentage values to each item or data. They user will have to be correct in their numerical entries on option D, or the program Will give them an error message and ask them to recalculate their choices.

7. Finished Worksheets can be printed on paper or downloaded to PDA's (Personal Digital Assistants). (FIG. 1, line 105).

8. This will give users the opportunity to react with their newly created Worksheets (FIG. 1, box 45 and FIG. 3) in the manner of their choosing.

In the AUDIT section,

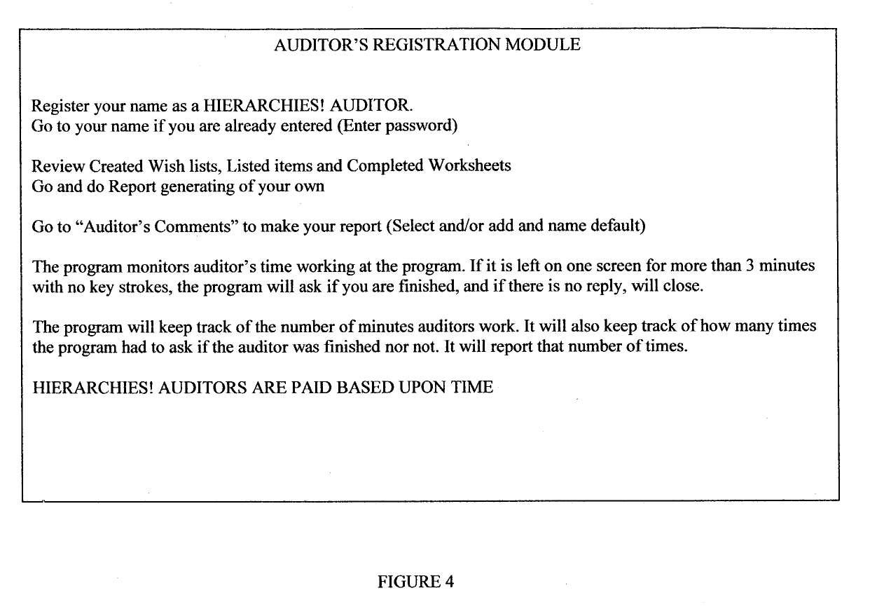

1. Auditors enter the “AUDITOR's REGISTRATION MODULE” (refer to FIG. 1, box 75 and FIG. 4). They are given the option of registering their name, address and other common identification features. They are also allowed to open up pre-existing password protected files. From this point they may go to review Wishlists, Worksheets, listed items and completed Worksheets. They are given another option of returning to password protected “Auditor's Comments.” The AUDITOR's REGISTRATION MODULE (FIG. 1, box 75 and FIG. 4) also house the Auditor's payment report, designating the amount of time the Auditor spends at the program. This option supplies data for time spent and allows for payment options based upon that time.

2. Auditors can go from the AUDITOR's REGISTRATION MODULE (refer to FIG. 1, box 75 and FIG. 4) to AUDITOR's PREPARE THEIR OWN WORKSHEETS FOR AUDIT (refer to FIG. 1, box 82). This option connects to the WORKSHEET CREATION MODULE (FIG. 1, box 45 and FIG. 3). Auditors will have the same options as “regular users” of the program to audit previous Worksheet performance by others, or create new ones for themselves, or any conceivable combination thereof.

3. Users and Auditors have the option of opening the AUDITOR's PRINTED REPORTS (refer to FIG. 1, box 95). This password protected entree will permit qualified users to view previous Auditor's Reports. This option is also connected to the Worksheet Creation module (FIG. 1, box 45 and FIG. 3).

For users with PDA's (Personal Digital Assistants), users will have the option of synchronization and download of completed Worksheets (refer to FIG. 1, box 45 and FIG. 3) through line 105 (FIG. 1). Users with hand operated computers will not need the option of download, because the entire program will be operable on the one unit. This is also true with laptop and regular desktop computers. Uploads will be available through the user's PDA (Personal Digital Assistant) to the main computer through UPLOAD FINISHED WORKSHEETS BACK INTO CENTRAL COMPUTER (becomes permanent and unchangeable). (Refer to box 59 FIG. 1. There is a hand entry option in line 115 (FIG. 1) to allow paper to be used and uploaded back into the central program.

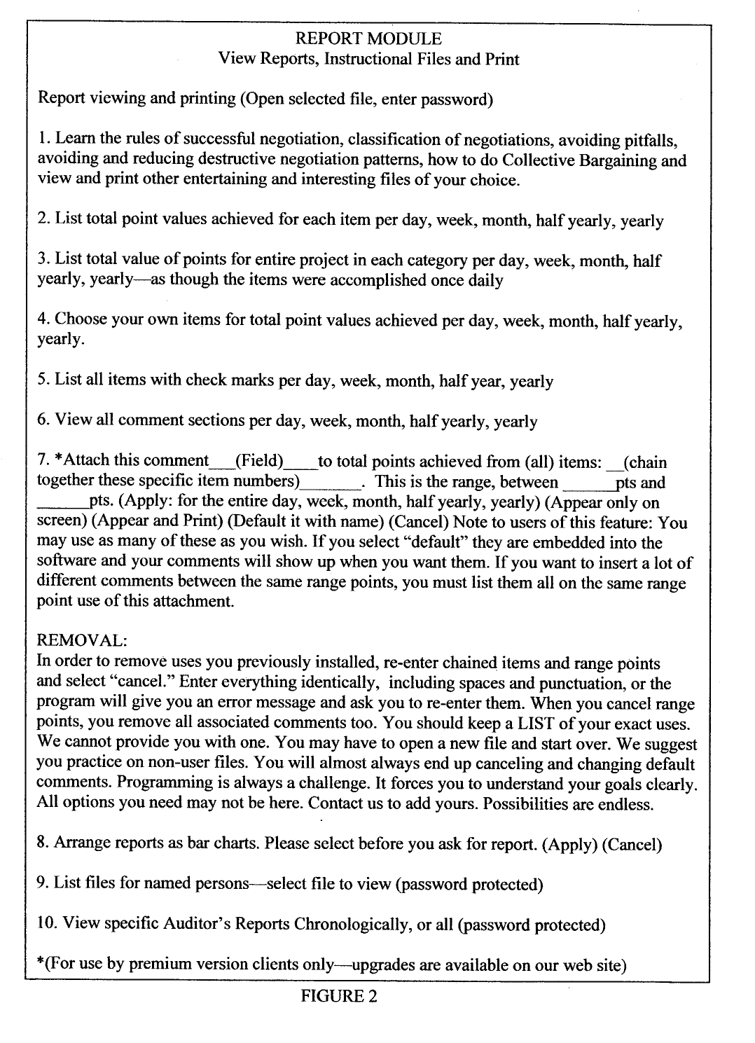

There is an auditor's feedback loop between the AUDITOR's PREPARE THEIR OWN WORKSHEETS FOR AUDIT (refer to FIG. 1, box 82 through line 84 and 86) to the WORKSHEET CREATION MODULE (refer to box 45, FIG. 1 and FIG. 3). There is an auditor's feedback loop between AUDITOR's PRINTED REPORTS (refer to box 95, FIG. 1) and the WORKSHEET CREATION MODULE (refer to FIG. 1, box 45, and FIG. 3) through line 85 (refer to FIG. 1). There is an auditor's feedback loop between the REPORT MODULE (refer to FIG. 1, box 65 and FIG. 2) and the WORKSHEET CREATION MODULE (refer to FIG. 1, box 45 and FIG. 3, through line 100 (FIG. 1). There is a user's feedback loop between UPLOAD FINISHED WORKSHEETS BACK INTO CENTRAL COMPUTER (refer to box 59, FIG. 1) and the WORKSHEET CREATION MODULE (refer to box 45, FIG. 1 and FIG. 3) through line 120 (refer to FIG. 1).

The REPORT MODULE (FIG. 2 and FIG. 1, box 65) offer the following reports:

Report Viewing and Printing (Open Selected File, Enter Password)

1. Learn the rules of successful negotiation, classification of negotiations, avoiding pitfalls, avoiding and reducing destructive negotiation patterns, how to do Collective Bargaining and view and print other entertaining and interesting files of your choice.

2. List total point values achieved for each item per day, week, month, half yearly, yearly

3. List total value of points for entire project in each category per day, week, month, half yearly, yearly—as though the items were accomplished once daily

4. Choose your own items for total point values achieved per day, week, month, half yearly, yearly.

5. List all items with check marks per day, week, month, half year, yearly

6. View all comment sections per day, week, month, half yearly, yearly

8. Arrange reports as bar charts. Please select before you ask for report. (Apply) (Cancel)

9. List files for named persons—select file to view (password protected)

10. View specific Auditor's Reports Chronologically, or all (password protected)

There are several preferred and exemplar programming options.

The first programming options is the following: *Attach this comment ______ (Field) ______ to total points achieved from (all) items: ______ (chain together these specific item numbers) ______ . This is the range, between ______ pts and ______ pts. (Apply: for the entire day, week, month, half yearly, yearly) (Appear only on screen) (Appear and Print) (Default it with name) (Cancel) Note to users of this feature: You may use as many of these as you wish. If you select “default” they are embedded into the software and your comments will show up when you want them. If you want to insert a lot of different comments between the same range points, you must list them all on the same range point use of this attachment.

*(For use by premium version clients only—upgrades are available on our web site)

In order to remove uses previously installed comment fields, re-enter chained items and range points and select “cancel.” When point ranges are cancelled, all associated comments are also removed. A screen may be provided with the lists of programming point ranges and comments made for convenience of the programmer.

The second exemplar programming option is the following: Users can use the VALUE ASSIGNMENT MODULE, (refer to FIG. 1, box 35) to program the following user defined choices: they will have the option to assign values to those data or lists, by going to the VALUE ASSIGNMENT MODULE, box 35, FIG. 1, which allows them 4 choices: A. All equal, B, Incremental values from most important at the top to least important at the bottom, C Assign your own point values to each item and D, Assign your own percentage values to each.”

If they select A choice (box 35, FIG. 1) they will automatically see all values equal. If they select B choice (box 35, FIG. 1) the most important item will be at the top and then incrementally from there to the bottom, depending on the number of objects stored on the list, and choice C (box 35, FIG. 1) they will be given the opportunity to install point values to each item or data, and Option D (box 35, FIG. 1), will be allowed to assign percentage values to each item or data. They user will have to be correct in their numerical entries on option D, or the program will give them an error message and ask them to recalculate their choices.

The third exemplar programming option is the following. Please note the VALUE ASSIGNMENT MODULE (refer to box 35, FIG. 1) is used for both Wishlist programming (refer to box 50, FIG. 1) and also the Worksheet Creation Module (refer to box 45, FIG. 1 and FIG. 3).

In addition, password security protections are available in the files and sections 1-5 below:

1. All user files

2. All auditors' files

3. All data base files

4. All files relating to sexual issues and discussions

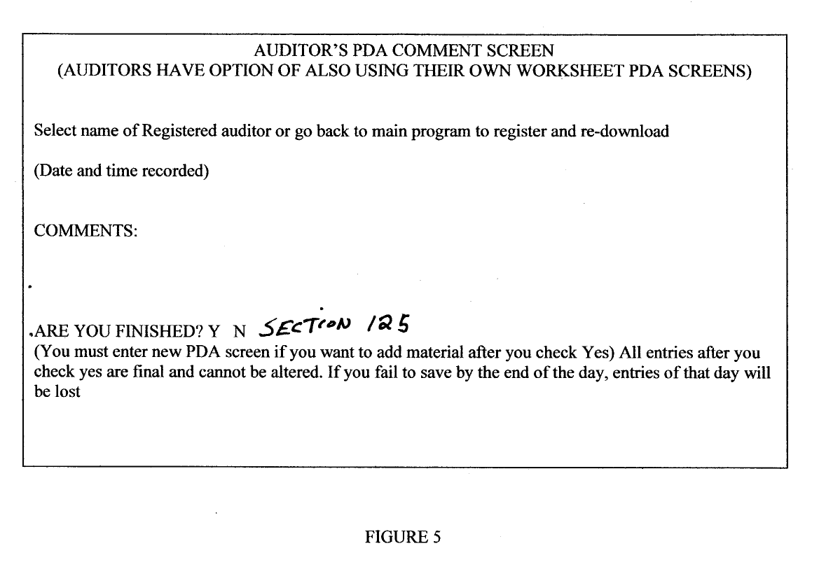

5. “Are you finished?” (refer to FIG. 1, box 45 and FIG. 3 Section 98 and FIG. 5, Section 125) These sections require that as soon as they are entered, they are permanently recorded in the software as to exact time and date and are not possible to change.

Further, data base files containing the following are created as follows.

1. Names of Participants

2. Names of Auditors

3. Comments of Participants

4. Comments of Auditors

5. Data base of items with values

6. Data base of items with check-offs

7. “Range of points” files with associated comments

8. Programmers' options files for new materials and sections

The options in which this invention can be used consist of both linear and non-linear methodology. Non-linear includes the regular use of an auditor. Linear does not involve use of an auditor. While it is true that audit functions are still quite possible in this invention even without hiring a separate auditor, if no audit function is used, by definition it is linear. The importance of learning new methods of negotiation cannot be over-estimated. Contained in print files are various interesting and entertainingly written instruction forms for those new methods. All are aimed to generate a new arena of co-operation and give and take. Complexity is eschewed in favor of direct statements of avoiding pitfalls, learning new techniques and defining substitution methods. The instructions are written in direct, straightforward language so they could easily be translated, allowing even those who don't share the same language a chance at successful negotiation. Even if the users of this program don't find an exact match for their needs, they certainly will think more about the process before they start.

The following describes several situations in which the present invention may be adapted to be used.

The language of medicine and surgery is composed of unconnected data bits and disparate language. Yet there is a real need to order them and provide relative value and decide payment rates for various combinations. An example of this is the Evaluation and Management Codes (E/M Codes) that Government has provided to try to teach health care providers that some combinations pay more than others. Evaluation and Management Codes are exceedingly complex. Working with them is a difficult burden. The penalties for inadequate compliance are severe and can even result in criminal prosecution.

It's not much better for Government. It has become expensive for Government to monitor and audit chart notes and medical records, generally requiring highly experienced, medically trained auditors. Even then, the ability to get uniform results is difficult, because often the data they evaluate has not been arranged in an orderly fashion. The only reliable way to obtain repeatable audit information from Evaluation and Management Codes is to use software with Governments' algorithm built into it, no matter who does the auditing. Attempting to audit without that requires laborious counting and classification of Evaluation and Management features for each medical record.

Findings are often recorded in no specific recognized order. Often they appear quite random, even though providers were trained professionally to have order to their chart notes. Government complains that inadequate record keeping costs hundreds of millions every year, resulting in unnecessary payments for unnecessary medical care. I would greatly improve audit capability if non-medically trained auditors could accomplish accurate, repeatable medical record audits. It would also be considerably less expensive to hire them. The solution is a non-linear software program that permits installation of hierarchical values to disparate concepts, exactly what this invention does. Government's algorithm can be fit into my invention like a foot into a shoe. When non-experienced auditors look at charts, all they have to do is identify specific Evaluation and Management comments; check them off, and this invention will perform the necessary calculations.

In another example, consider that most individuals have tasks to perform that are connected to the calendar. The Personal Digital Assistant (PDA) presents an opportunity to routinely and conveniently record task completions. Being small and becoming successively less expensive, it is becoming more and more ubiquitous. They can be carried around daily and if a program is constructed for them that requires only minimal entries, e.g., by touching the screen with a stylus, recording compliance becomes much easier. The same is true for verification. Auditors could simply verify completion by carrying around an identical duty list if real-time verification were desired. When this is combined with statistical reporting and some over-lapping auditing of features already audited, verification can become extremely reliable.

In another example, educators have a continuing challenge keeping the attention of their students and encouraging their participation in an age of mass multi-media entertainment, popular television, highly rhythmical, thumping music and adolescent hormonal changes. The key to that attention span is direct participation by students. This invention allows educators to craft their lessons into my format, directly involving each and every student, knowing that each will be evaluated, perhaps by their own peers, and issued a numerical grade of their performance, by using the reporting part of this invention.

In addition, the present invention is a tool. It is not designed for nor intended to practice law, psychology, education or medicine. Rather, it is designed for those and other professionals in their practice, should they wish to use it as will be illustrated below. It is also designed for general use by those who find it valuable or entertaining.

Further as is common with computer programs, the present invention may be embedded and chained into others, thereby expanding the usefulness and scope of the entire application. This is important because this program, despite its apparent simplicity is capable of amassing enormous amounts of data.

The following consists of exemplary scenarios; comprising a summary of some but not all uses of this invention would proceed into the following attributes:

The single user using the present invention with a psychotherapist would enter the program at one of two levels signing in and selecting a version, either professional or individual. If they decided on the professional version, they would be excused from entering the offered program choices for selecting behaviors, and could install their own behaviors or data.

By selecting the individual/family version, (refer to FIG. 1, box 25, select A) they would be delivered to the programs' selection of possible behaviors, substitute behaviors, task lists and many other choices (refer to FIG. 1, SUB CHOICE CATEGORIES, box 30, select A). They would select the ones' that suited their needs, for example, directing their study habits more successfully, or perhaps avoiding a habit of arriving late to works, etc.

As an illustration, a 43 year old married female has been served notice by her employer that she will be fired from her job as a waitress unless she stops arriving at her shifts late each day of work. She has two children in college and she and her husband need her job financially to afford to pay their bills and continue their children's education. Her husband is exasperated with her and they have not had marital relations in almost 6 months. They argue frequently and now occupy separate bedrooms. Her husband served her notice that unless she starts going to a psychotherapist, he will serve her with a divorce order. Lately she has become severely depressed and cries frequently.

Her husband refuses to attend the psychotherapist, telling his wife: “This is your problem, not mine.” At her first meeting with her therapist, her therapist soon discovers that as a child, her client was frequently locked into a closet as a form of punishment by her alcoholic mother. It appears to the therapist that her client is suffering from a form of agoraphobia, or “fear of open spaces.” Since time is of the essence in this situation, her therapist recommends this program to assist her in desensitization from her fear, combined with a family treatment, drug treatment by a psychiatrist and a personally designed program.

She advises her client to search this invention under “What do you want?” (refer to box 26, FIG. 1) for behaviors that she enjoys, and some healthy substitution behaviors (FIG. 1, SUB-CHOICE CATEGORIES, box 30, choice A). Even though this is not technically a negotiation, it would be helpful if she understood power issues as they relate to both her employer and her husband, and suggests she read about it in the program. (refer to FIG. 2, choice 1) Going on to discuss activities, the husband and her client enjoy bowling, although they have not bowled in over a year. Her client has gained considerable weight and they decide that a new walking program would help as well. Their goal is to persuade her husband to walk with her, although at first they don't think he will. Her client enters my invention and develops the following Wishlist (refer to box 21, FIG. 1, select “yes” and refer to FIG. 1, DATA BASE MODULE, box 25, Select A—SUBCHOICE CATEGORIES, box 30, Select A and B):

1. I want my husband to spend time with me and stop warning me about a divorce

2. I want to go bowling with my husband again

3. I want to continue working, which I do enjoy, but am worried about being fired

4. I want to go back into my husband's bedroom and start having marital relations again

5. I want my children to appreciate me more. They rarely call and I hardly ever see them

6. I want to stop crying all the time and lose weight

7. I want to enjoy going shopping. My children's college has wiped out our savings

8. I want to stop shaking when I go outside

The client goes to the VALUE ASSIGNMENT MODULE (refer to FIG. 1, box 35 select B). Assign incremental value to each with the most important at the top to the least at the bottom. The list is printed and several copies are made. In the mean time the patient has been recommended to a psychiatrist for anti-depressant medications and anti-OCD medications.

After consultation with her therapist, they go into this invention and develop the following Worksheet: (refer to FIG. 1, WORKSHEET CREATION MODULE, box 45, then VALUE ASSIGNMENT MODULE, box 35, choice C)

| | | |
|---|---|---|
| 1. | When the house is quiet and nobody is home, put | 10 pts |
| | an empty chair down in the center of the room and | |
| | pretend your mother is sitting in it. | |
| | Tell her how you feel. | |
| 2. | Go for 1 mile walk today | 5 pts |
| 3. | Eat no dessert this evening | 5 pts |
| 4. | Above and beyond | 5 pts |
| 5. | Didn't cry today | 5 pts |
| 6. | Tell your husband you love him | 3 pts |
| 7. | Go bowling by yourself | 3 pts |
| 8. | Purchase a new dress | 1 pt |
| 9. | Arrive at work late | −5 pts |

Her psychotherapist assists her in loading this program into a Personal Digital Device (refer to FIG. 1—to PDA, line 105) she has just purchased. The patient's husband has one at home, and they decide to “show him her Worksheet” tonight. This will be an “above and beyond” and she will get 5 pts credit for that item. A strategy here is to encourage her husband to work with her in help explaining use of the PDA to her, and learning how she will be using it. He will also be granted the opportunity to see her progress reports based upon her point values achieved (refer to FIG. 1, REPORT MODULE, box 65, and to FIG. 2, choice 2). They decide that no auditor will be used in her case, but her psychotherapist will continue with counseling therapy along with use of this invention.

The patient returns to her therapist and her results of the first week are uploaded back into the main computer program and a report menu (refer to box 59,“Upload finished worksheets, etc”, (refer to FIG. 1, box 65, and FIG. 2, REPORT MODULE) is selected with the choice: “List total point values achieved for each item per week.” (refer to FIG. 1, REPORT MODULE, box 65, and then, FIG. 2, Choice 2) Then the therapist selects “Arrange report as bar charts.” (refer to FIG. 1, box 65, then FIG. 2 REPORT MODULE, choice 8) The report is printed for the patient, and its results are discussed at their next meeting.

The husband is deeply impressed with this program. The therapist is able to consult with him privately. They agree that if his wife starts showing significant progress as demonstrated by the point values achieved in this invention, as well as his own evaluation, he will go bowling with her and have marital relations with her again. But he feels she must first lose at least 5 pounds.

The strategy here is to change the patient's behavior and show her that as she achieves specific goals, her life will improve. The same is true for her husband. In most cases, patients will tire of using this invention, finding it no longer necessary, tiresome and superfluous. Actually that is its goal and purpose.

In another illustrative situation, a married man is served with a subpoena for divorce, issued from his wife. He is notified to seek legal advice. He selects a family law attorney who uses this invention in his practice. The man appears at his attorney's office and is instructed about this invention, how it works and provided with forms explaining it to take home and read, ask questions and decide if he wishes to use it in this process. He is informed that using it may save him money, because the longer an action takes, the more it will cost him. This method might help reduce that time significantly. In his next consultation with his counsel, he is asked if he has any questions about this, or if he has any reservations about taking part. He is then presented with a document from his attorney that explains the program in great detail and asked to sign if he wishes to use it. He is advised that he can quit it at any time, but will be required to pay any and all fees, including those of auditors, incurred up to that time.

After thinking about it for a week, this client agrees to use this program. The primary reason he does is to try to save as much money as possible and get this process over with so he can go on with his life. His attorney presents him with documents he is required to fill out, and he is requested to purchase a PDA, (personal digital assistant) which may or may not be used in the program. The documents include all of the forms that his attorney normally uses, plus those specific to this invention. He is provided a copy of the computer program which operates it. He is required to pay separately for all of these, which are not included in the professional fees of his attorney.

His attorney asks him to load it into his home computer and start working on Wishlists (refer to FIG. 1, box 50, SUB-CHOICE CATEGORIES, box 30, choice A) of things he wants from his estranged wife. He is surprised to see that there are a number of choices included with this computer program that contain marriage dissolution choices of various kinds, for both sides. (refer to FIG. 1, SUB-CHOICE CATEGORIES, box 30, choice A) He and his wife have some (not unexpected) emotional issues that he is concerned will come up from his wife and delay and/or complicate the dissolution process. He calls his attorney to ask how those should be handled. His attorney advises him that as an attorney he cannot practice psychology, but will be glad to refer him to one if he thinks there is a chance the marriage can be saved, or if his client has questions about handling those issues. The client declines the offer, preferring to deal with these within the program himself. He sees some interesting files in the REPORT MODULE (refer to FIG. 1, box 65 and then FIG. 2 choice 1) on negotiation issues. Rather than “psycho-babble” they seem to be analytical and direct. He is particularly interested in power differentials, how to recognize and deal with them, thinking that they might even help him at his work.

He is concerned about increased costs. There is some discussion on whether he wants to hire a separate auditor sometimes used in this program. After being told that the auditor has an hourly charge for both time spent at the computer program and real-time investigation, he declines, believing that this would be too expensive and unnecessary. His friends have repeatedly told him that it can take years to finish a divorce and anything that increases that time or cost is not a good idea. Besides, he feels that this is just a “gimmick” for attorneys to get more money.

The man opens up the “What do you Want?” (refer to FIG. 1, box 26, and SUB-CHOICE CATEGORIES, box 30, choice a) section of the software and creates a list of items that are important to him, and assigns them point values and arranges them into a hierarchy: (refer to FIG. 1, box 50, and VALUE ASSIGNMENT MODULE, FIG. 1, box 35, choice C)

1. The marriage is over. Let's try to get the process over with (10 pts)

2. His wife must turn over all his credit cards to him immediately (8 pts)

3. His wife must stop calling his office, yelling at his secretary and embarrassing him (8 pts)

4. He wants his wife to stop accusing him of giving her a sexually transmitted disease (8 pts)

5. He does not want the legal experience with her to be embarrassing, full of recriminations and threats (8 pts)

6. He wants to keep the vacation property they had purchased 6 years ago as a place he can live (6 pts)

7. I refuse to pay any more than 4 years of college for each of my two children (6 pts)

8. I wish to keep the Porsche (5 pts)

9. All telephone calls from his estranged wife must cease (5 pts)

10. He wants to see the kids weekly (2 pts)

He and his attorney go to see his estranged wife and her attorney. He is nervous and upset, fearing that this will be another yelling match. His attorney has a list of their assets and their estimated monetary value, a document that is always used and demanded by the opposing attorney. The client is amazed at how much work and effort it took to prepare the list. Fortunately, the computer program his attorney suggested to him has a list of household items to make it easier for him to prepare it. (refer to FIG. 1, SUB-CHOICE CATEGORIES, box 30, Choice A) It saved him many hours. If the program makes this afternoon any easier too, it will also be well worth using.

They enter the room and his wife has a rigid look on her face, but she is not yelling yet. Her attorney shakes hands with him and asks him how he liked using the computer program. He says that so far it saved him time and helped clarify some things. Everyone sits down. The attorneys tell their clients it's time to exchange their lists. He hands his over to her and nervously glances at hers:

1. Your extra-marital affair caused me grief, sadness and anger (10 pts)

2. I am now finished with antibiotics and fortunately am HIV negative (10 pts)

3. I demand the house and the kids (8 pts)

4. I demand that you pay for their graduate school, if they qualify and wish it (6 pts)

5. I want to keep at least one credit card for the transition of this divorce for 6 months (6 pts)

6. I want you to tell the kids why this happened and explain it to them (5 pts)

7. I am sick and tired of your constantly criticizing me in public (5 pts)

8. I do not want to see or be reminded about your girlfriend (3 pts)

9. You need to start taking some responsibility with your children (3 pts)

10. I want you to pay for all attorney fees, and not consider them part of the divorce community property split. (2 pts)

Everyone leaves the room and each have a discussion with their respective attorneys. Their attorneys advise them to look for things that they can each agree upon. They advise them that if they can each apologize about something on the opposing list, it would help both, reduce costs and expedite the dissolution. The man is surprised that his wife was tested for HIV. He never had been himself. He feels that he can apologize about that. He also feels that since the marriage is over, he can apologize about the extra-marital affair, since that too will probably be over soon and in any case his estranged wife will not be seeing any of his girlfriends.

The wife feels that she can easily not take the Porsche, which she hates anyway. She too wants to end this process. She has examined the instructional files in the program and they contain a discussion on “slash and burn” behaviors. (refer to REPORT MODULE, box 65 FIG. 1, then FIG. 2, Choice 1) She knew that her husband's father had left his mother and him at an early age. He seems to be repeating that behavior. She realizes now that without therapy, it probably would be impossible for her husband to stop this. And she wonders if he is still drinking a lot. But she is still furious. She will want him to take some more responsibility with his kids and wishes to have some items on her estranged husband's PDA (refer to FIG. 1, box 45, and FIG. 1, line 105) concerning their kids. Knowing that, she feels a bit relieved and is prepared to continue the process. Everyone returns together to prepare Worksheets (refer to FIG. 1, box 45, WORKSHEET CREATION MODULE) from their lists.

The husband makes a brief apology to his wife. She stares at him, somewhat surprised because he never had before. She hardens her resolve to demand he take responsibility for his kids. The husband is pleasantly surprised his wife is not screaming at him. He thinks he sees a tear in her eye that was clearly unexpected. She had been cold and angry before. In the past, the presence of strangers was no impediment to her expressing her anger and hatred at him. Perhaps this won't be so bad after all. So far the attorneys have said little.

They start discussing the Worksheets. (refer to FIG. 1, box 45, and VALUE ASSIGNMENT MODULE, FIG. 1, box 35, choice C) Although there is some disagreement, since the marriage is over and the husband apologized, some emotional issues are now off the table. They work out the following Worksheets

Estranged Husbands Worksheet: (refer to FIG. 1, WORKSHEET CREATION MODULE, (refer to FIG. 1, box 45, and FIG. 1, VALUE ASSIGNMENT MODULE, FIG. 1, box 35, choice C)

1. He will go out to lunch with each of his two children separately once/week to discuss his relationship with them (10 pts)

2. He will discuss his intentions regarding the payment of their college costs with them (5 pts)

3. The husband will pay all psychology counseling fees and record the dates he sent the checks out (5 pts)

4. He will call a real estate broker to start making arrangements to sell their vacation property (3 pts)

5. If he misses a week of seeing one of his children he will record that on his PDA (−5 pts).

Estranged Wife's worksheet: (refer to FIG. 1, WORKSHEET CREATION MODULE, box 45, and also FIG. 1, VALUE ASSIGNMENT MODULE, box 35, choice C)

1. She will record the visits and calls to her attorney each week, since he will be paying for them separately (10 pts)

2. She will use his credit card and keep track of the charges for each use, recording each charge episode in the PDA (5 pts)

3. She will seek psychological counseling at her husband's expense and check off each day she goes (5 pts)

4. She will record each time she calls his office on her PDA if it does not concern their children (−5 pts)

At the end of the session, a secretary downloads the Worksheets into the husband and wife's PDA. (refer to FIG. 1, line 105, download to PDA). His wife knows how to use it, but he does not. A secretary helps him learn how to do the entries, and they practice with one of the law firms own PDAs that are empty.

The meeting has taken 4 hours. The estranged couple are both exhausted. But both are surprised at how smoothly it went. They are both surprised that their Worksheets (refer to FIG. 1, box 45, WORKSHEET CREATION MODULE) are so short. The husband is a little nervous about seeing his children and talking about this situation with them, but he feels it is probably necessary. Perhaps he will consider contacting that psychotherapist his attorney recommended after all. Maybe that will help make it easier for him. He calculates the costs so far in his mind. Since the emotional issues are somewhat resolved, he feels that they will probably reach a financial agreement soon, perhaps at the end of the next meeting or one more after that at worst. His friends had told him that this part could take months and cost him tens of thousands of dollars in attorney fees. At this rate, it clearly will not. A nagging thought erupts just as he presses the elevator button: “What if we had used this program two years ago? Would we be here now? The elevator door opens and he steps in.

The wife definitely feels better that her husband is going to have to start taking some responsibility for his two children, who are teens. The kids have been sullen, uncooperative and their grades have dropped. She is afraid that she is smelling cigarette smoke in the house, but is not sure which youngster is smoking. Hopefully it is only tobacco, but she's not sure. She had been crying almost every day. Her psychotherapist had told her that her husband was not paying her fees. She feels somewhat vindicated that his Worksheet (refer to FIG. 1, WORKSHEET CREATION MODULE, box 45) contains more items than hers, but a part of her understands that talking with their kids is going to be very difficult for him. So far she has gotten pretty much what she expected. What surprised her most is that he had apologized. It was a lousy apology, but apparently seeing the list (refer to FIG. 1, SUB-CHOICE CREATION MODULE, box 30, choice A, and VALUE ASSIGNMENT MODULE, FIG. 1, box 35, choice C) in front of him had an impact. She was still furious and very hurt, but it was a better day than she expected.

In another illustrative situation in which the present invention of non-linear negotiation can be used, father and son have not been agreeing lately. Son is now 14 years old and is sullen, stays for hours in his room, which smells horrible and is filthy. Son's grades have been dropping and father fears that his son might be going in the “wrong crowd.” Father has been obsessed with getting a business account which if he achieves it, will provide significant college money for his son and daughter. He spends very little time at home. Mother also works. Father hears about this invention from an associate at work who tried it and suggested that he should “look into it.” This associate suggests that he was able to get his whole family active again and they are no longer just arguing about “chores and duties.” The daughter is now almost 18 years old and this is her last year of high school. She is well adjusted, but has been complaining that she hardly ever sees her father. The use of a sibling for an auditor may not be appropriate, but in this case the sibling is reliable and mature. Deciding these issues is very much a part of the use of this invention.

The father brings three Personal Digital Devices home and gives it to his son and daughter, who are delighted and surprised with the gifts. He keeps one himself. They were on sale for less than 65 dollars each after a store coupon was used. The gifts get their attention. He tells them that their new present is “conditional upon using the program.”

The father sits down to this program and goes to FIG. 1, Licensing and disclosures, box 21, and selects “yes.” He then goes to the Data base Module and selects “Individual and family” version, box 25, and to “What do you want?” (refer to FIG. 1, box 26, and to FIG. 1, SUB-CHOICE CATEGORIES, box 30, choice A and B) He selects the following items and adds some of his own. He selects choice B from the Value Assignment Module, (refer to FIG. 1, box 35) allowing each item to have an incremental value from top down.

Wishlist by father, expected of son

1. Don't drink and drive

2. Quit talking back and complaining

3. Take out the garbage when necessary

4. Cut the lawn weekly

5. Come to dinner with the rest of family

6. Take the car in for oil changes and maintenance

7. Quit driving his friends all over town and using gas to do it.

8. Do his homework.

9. Fill the car up with gas after you use it.

10. Quit leaving his stuff all over the place

The son sits down to this program and selects the “What do you want” (refer to FIG. 1, box 26) menu selection. Then the SUB-CHOICE CATEGORIES, (refer to box 30, choice A and B). Out of the lists of behaviors and choices, he selects the following, and adds some of his own.

Wishlist by son, expected from father:

1. Quit getting on my “case.”

2. Let me have the car when I go out on dates.

3. Let me go out with my friends more often.

4. Don't embarrass me in front of my friends.

5. Let me work a part-time job after school

6. Wants to go to college out of town.

7. Pocket money and bigger allowance.

8. Wants a car.

9. Cool vacations.

10. Designer clothes.

The son selects choice B. (refer to FIG. 1, VALUE ASSIGNMENT MODULE, box 35, option B) “Incremental value from top to bottom” out of the Value Assignment Module.

He feels that he really wants some designer clothes, since his friends have them, but is afraid to point this out as his top item. Still he is sick and tired of his father complaining, since that is all he hears from his father. So that gets top billing of importance. The son opens the REPORT MODULE (refer to FIG. 1, box 65, and FIG. 2, choice 1) file and looks in on some selected files on negotiation. It is obvious that his Dad is the boss and there is an inequality. But they have just been avoiding each other, which could also be described as a “slash and burn” behavior on the part of both. And when they talked, all the father did was harp on chore and homework completion. The son felt his room was his only refuge. The son had never thought in those terms before.

The father feels that his daughter could be involved in their family life during her last year of high school more than she presently is. The father and son agree that she should be auditor for this situation. She is flattered and interested.

Since the family has not really spoken together for months, nobody has an idea where to start. They decide to look into this program for some ideas. They select the item to be printed from the print menu: “Collective Bargaining Instructions.” This file contains a detailed list and explanation of how to conduct Collective Bargaining (refer to FIG. 1, box 65, REPORT MODULE, and FIG. 2, Choice 1) under this program. It gives them some useful ideas and they proceed to develop Worksheets (refer to FIG. 1 box 45, and to FIG. 1, VALUE ASSIGNMENT MODULE, box 35, choice C) for each. So far it is fun and interesting.

Work sheet presented by father

| | | | |
|---|---|---|---|
| 1. | Quality of grades | 8 | pts |
| 2. | Obeying curfews | 7 | pts |
| 3. | Daily check of belongings lying around the house | 5 | pts |
| 4. | Enjoying pleasant conversations during dinner | 5 | pts |
| 5. | Every-other day check of the garbage. | 2 | pts |
| 6. | Check to see if the lawn is cut weekly | 3 | pts |
| 7. | Monitoring nights of dinner attendance - | 2 | pts |
| | when work or family don't interfere | | |
| 8. | Putting gas in the car after use | 2 | pts |

Work sheet presented by Son

| | | | |
|---|---|---|---|
| 1. | Having Dad come to sports events | 10 | pts |
| 2. | Looking for a car. | 10 | pts |
| 3. | Gathering information about out of town colleges | 8 | pts |
| 4. | Allowing me to use the car to go out with | 8 | pts |
| | friends on off school nights. | | |
| 5. | Listening for favorable comments from Dad | 8 | pts |
| 6. | Permission to allow me to look for an outside | 7 | pts |
| | job if my grades are good | | |
| 7. | Allowing me to have more time for myself. | 5 | pts |
| 8. | Granting an increase in my weekly allowance | 6 | pts |
| | so I can purchase designer clothes | | |

FATHER's COMMENTS ON WISHLIST: (refer to FIG. 1, box 50) The Father states that luxury vacations are impossible. There's no way we can afford it. We simply can't afford these expensive items like another car, or designer clothes. Those must be purchased with your own earned money. Auto insurance for minors is very expensive, and in order to “earn enough” for you to pay for it yourself, you will have to work long hours, which will probably be harmful to your GPA.

However, I think I can agree that I ride you too much. We need to establish a reasonable number of hours you can work outside, but this will depend on your behavior. I can agree with some of your requests, but certainly not all. You rarely perform duties which are a part of this family. As long as I support you, I expect you to help out. Sometimes you act as though you are not a part of this family and that makes me angry.

SON's COMMENTS ON WISH LIST (refer to FIG. 1, box 50) Son says that: “I wish to work outside of school so I can afford to pay some things myself and don't have to come to you to ask for it. I want more time with my friends and I am tired of you riding me.”

“I can mow the lawn weekly and promise to leave the gas tank filled up after I use it. A little more money would really help me. Why can't we go to look for a car together?”

They agree to final Worksheets (refer to FIG. 1, box 45) WORKSHEET CREATION MODULE, and VALUE ASSIGNMENT MODULE, box 35, choice C) and go to the Worksheet Module (refer to box 45, FIG. 1) to place them in. They are then downloaded into the PDA's (refer to FIG. 1, line 105) since the auditor agrees they are “workable.”

Father's Worksheet: (refer to FIG. 1, VALUE ASSIGNMENT MODULE, box 35, choice C, and FIG. 1, box 45 and FIG. 3)

1. Father will come to as many sports events as possible, for each one the score they get is: 5 pts

2. Father will try to make favorable, supportive comments to son, and for each occurrence he gets: 5 pts

3. Father will grant an increase in allowance based upon number of points son gets over the first month. 5 pts

Son's Worksheet: (refer to FIG. 1, VALUE ASSIGNMENT MODULE, box 35, choice C, and FIG. 1, box 45 and FIG. 3)

1. Son will cut lawn weekly and get this number of points: 5 pts

2. Son will fill up gas tank after use by friends and get this number of points: 5 pts

3. Son will clean up his room and store belongings away each day for points: 5 pts

AUDITOR's REGISTRATION AND COMMENTS ON WORK PERFORMED: Auditor's Comments: (refer to FIG. 1, AUDITOR's REGISTRATION MODULE, box 75, FIG. 1, and FIG. 4, AUDITOR's PDA COMMENT SCREEN, (FIG. 5 and FIG. 1, line 105) AUDITOR's PRINTED REPORTS, (FIG. 1, box 95, and FIG. 1 box 65 and REPORT MODULE, FIG. 2, option 10)

The older sister, as the auditor agrees with these Worksheets to both Contributors. They are turned in at the end of each week for installation into the REPORT PRINTING MODULE (refer to box 65, FIG. 1, and FIG. 2, option 2, weekly) or a report, which all three can examine.

At the end of 4 weeks, the auditor will prepare a report from the REPORT MODULE (refer to box 65, FIG. 1, and FIG. 2, Choice 2—weekly) and request payment from both Contributors. All parties agree to their Worksheets and the rate of pay that the sister will get as an auditor.

Auditor's Report: (refer to FIG. 1, AUDITOR's REGISTRATION MODULE, box 75, and FIG. 2 option 10, and FIG. 4 also, AUDITOR's PDA COMMENT SCREEN, (FIG. 5 and FIG. 1, box 82 and 87), AUDITOR's PRINTED REPORTS, (refer to FIG. 1, box 95, and FIG. 2 option 10).

The auditor has examined the results of the reports. Steady progress has been made. It was agreed that the sister would be paid for her audit efforts, since the program strongly advises that all auditors are paid. (refer to FIG. 1, box 75, and FIG. 4, AUDITOR's REGISTRATION MODULE) She goes to the Auditor's Module in the program (FIG. 4, AUDITOR's REGISTRATION MODULE, and FIG. 1, box 75) which has kept track of her work and she reports 2 hours/week reviewing the reports and real time investigation of each contributor's efforts at their Worksheets. (refer to FIG. 1, WORKSHEET CREATION MODULE, box 45) The son and father have agreed to each pay her separately, the father a greater amount, since he is working. She earned 55 dollars for her efforts. She is pleased and excited, feeling like she has contributed to her family and earned good money at the same time. She purchases a nice outfit to go to her first college interview. The wife has been following the progress and seeing her family talk more than they ever have. Instead of arguing about chores, they have now started talking about current events and shared ideas about them.

In another illustrative situation in which the present invention may be used, the following is an example of this invention for data stream management and handling of governmental medical billing requirements. A podiatrist is a physician who specializes in the treatment of the human foot and ankle. A particular podiatrist has an opportunity to go to some nursing homes to perform a necessary and vital service, that is the trimming and grinding of nails and performance of a service called “routine foot care.” The problem is that routine foot care is a highly observed treatment by government, which fears that it is being “over-billed” and that unnecessary treatment, inadequately documented is regularly being performed. Any physician who performs routine foot care often will be under severe scrutiny for this. They risk governmental audits, investigations, financial penalties and even risk of criminal prosecution for relatively “mild” clerical errors. Clearly Government's view of clerical errors is different from providers: Providers view clerical errors of charting as simple mistakes. Government views them as Medicare fraud.

There is a real need to clarify whether routine foot care is covered prior to sending out bills for it. It must also be carefully documented and charted. This invention is almost ideally suited for this requirement as described below.

First, we look at Government's definition and rules for routine foot care (Excerpted from published Government data from Centers for Medicare & Medicaid Services, 7500 Security Boulevard, Baltimore Md. 21244-1850): “The presumption of coverage may be applied when the physician rendering the routine foot care has identified: (1) a Class A finding; (2) two of the Class B findings; or (3) one Class B and two Class C findings. Cases with findings falling short of these alternatives may involve podiatric treatment that may constitute covered care and may be reviewed by the intermediary's medical staff.”

These constitute what Government describes as “Class Findings.” Coverage every 6 months is additionally permitted as long as another list of diagnostic features related to lack of sensation and diabetes are also documented in chart notes.

It becomes obvious that these findings are complex and difficult to ascertain on a real time, regular basis, when many patients are examined and treated. Yet that is precisely Government's requirement. If physicians don't obey these findings, they are at risk of losing their license and worse.

Physicians can use this program to document treatment, classify findings, perform real-time calculations to identify whether a treatment is covered, and if necessary use those calculations to prove to Government that the treatment was properly documented and paid.

Review of the requirements indicates that the Government algorithm for treatment can be applied as a point range system.

As excerpted from published Government data from: Centers for Medicare & Medicaid Services, 7500 Security Boulevard, Baltimore Md. 21244-1850, for Medicare Coverage of Nail Debridement, “Medicare payment may be made for routine foot care when the patient has a systemic disease of sufficient severity that performance of such services by a nonprofessional person would put the patient at risk (for example, a systemic condition that has resulted in severe circulatory embarrassment or areas of desensitization).

The following physical and clinical findings, which are indicative of severe peripheral involvement, must be documented and maintained in the patient record, in order for routine foot care services to be reimbursable:”

The point values assigned below were obtained by analyzing the above routine foot care algorithm and working “backward” to set up hierarchical point values to agree with the various requirements for payment.

Class A Findings:

Non-traumatic amputation of foot or integral skeletal portion thereof (4 points)

Diabetes (4 points) (Coverage permitted every 6 months as long as (certain patient findings) are included)

Sensory neuropathy (4 points) (Coverage permitted every 6 months (as long as certain sensory deficit pathologies) are included)

Class B Findings:

Absent posterior tibial pulse (2 points)

Advanced trophic changes as evidenced by three of the following:

1. hair growth (decrease or increase) (0.7 points)

2. nail changes (thickening) (0.7 points)

3. pigmentary changes (discoloring) (0.7 points)

4. skin texture (thin, shiny) (0.7 points)

5. skin color (rubor or redness) (0.7 points)

Absent dorsalis pedis pulse (2 points)

Class C Findings:

Claudication (1.1 point)

Temperature changes (e.g., cold feet) (1.1 point)

Edema (1.1 point)

Paresthesias (abnormal spontaneous sensations in the feet) (1.1 point)

Burning (1.1 point)

a) Sensory testing of at least five areas of the feet randomly—absence of sensation must be present in at least two areas on either foot to diagnose peripheral neuropathy with loss of protective sensation; (0.8 points)

b) patient history; (0.8 points)

c) Physical examination of the feet to determine the foot structure and biomechanics of the feet; (0.8 pts)

d) evaluate need for special footwear, vascular status and skin integrity; and, (0.8 pts)

e) patient education. (0.8 pts)

The point system structure chosen in this program is designated to make “4” points eligible for coverage under Government's algorithm. The user of this program will go into the Worksheet (refer to FIG. 1, box 45) section and type in the descriptions and point values recorded above in this example. Although it would probably be rare, there is a possibility of a finding of 5 Class C findings, which could raise the point value over 4 and still not be covered according to the Government regulations. This underlines and proves the difficulties inherent in the “day to day” use of a complex algorithm in practice. Although Government is entitled to make the rules for their payment options, it is unlikely that those who made those rules would have provided them for their OWN day to day work!

The correct combination for Class C findings is 2.2

An incorrect combination for Class C findings would be 4.4 and 5.5

Readers who look at the original Government algorithm will see a logical fallacy that the items in section c cannot be used to add up to successful coverage of routine foot care. Government wrote its own rules. This program does not contain an option to avoid seeing a message if a number of points are between a range. You can avoid printing it, but you cannot avoid reading it. This was done to make verification effective for those who wished to use it for documentation only. But it will still expose the “logical fallacy” in the original algorithm. Thus, you will see two separate messages for that “error,” but can decide not to print them. It would be easy to install programming steps to avoid this by any number of methods. Programmers provide additional steps to avoid logical fallacies all the time. Any consistent programming method, yes/no gates, equal to, greater than or less than, point total configurations, etc. each has their own idiosyncrasies. In order to avoid them, it is necessary to combine those separate logical utilities. This program chooses deliberately not to. This inventor considers that one of its strengths.

A primary purpose of this invention is observation and monitoring. This inventor feels that if users wish to subvert the intent of the program, they should have to seek permission to change the programming intent first, perhaps by ordering a “special package” designed for a different purpose. But this is a practical world, and users still want to use this invention for documentation. We install 1.1 points for each in section c to cover the not very likely event that this will actually occur, and install messages to alert us to those possibilities. When it does, we will see TWO messages appearing, one that advises us that the visit is covered because it is over 4 points, and another advising us that it is an unusual circumstance dictated by Government's logical fallacy. We don't have to print both messages. But we see both.

This invention can then be programmed additionally by going into the REPORT MODULE (refer to FIG. 1, box 65 and FIG. 2 and selecting the 7^{th} choice), which is to allow point ranges certain statements. The point ranges chosen and their statements would be as follows:

If the point value were between 1-2 points, print: “This treatment is not covered”

If the point value were between 2-3 points, print: “This treatment is borderline and might have to be reviewed to find other associated findings, please review and re-examine patient and their chart.”

If the point value were between 4.3 and 4.5, print: “This treatment is slightly inconsistent with Government payment policy and might have to be reviewed to find other associated findings, please review and re-examine patient and their chart.”

If the point value were between 5.4 and 5.6, print: “This treatment is slightly inconsistent with Government payment policy and might have to be reviewed to find other associated findings, please review and re-examine the patient and their chart.”

If the point value were 4 and over, print: “This is probably a covered service for routine foot care, but please check the date of the last visit to be sure it was not earlier than 6 months.”

The user will then go to the upload menu (refer to FIG. 1, box 59) and after treating all their patients will upload the information back into the central computer. The user will then selects “Print reports” (refer to FIG. 1, box 65, and FIG. 2, select choice 2) and prints out that day's reports for each patient. The user can designate if they wish the message to appear on the report or just the screen. (refer to FIG. 1 box 65 and FIG. 2, choice 7). Users will have the option of programming defaulted comments to choose from, giving them an entire range of items to be printed at their volition. (refer to box 65, FIG. 1 and FIG. 2, choice 7) In this case, a user might pre-program the comment: “Today I administered trimming of the nails and calluses for this patient. The locations are as follows:” Users will then use the “Comments section” (refer to FIG. 3, section 90) under each PDA (refer to FIG. 3, and FIG. 1, line 105) screen to add locations and report further treatments.

In the use of this program, time and date are always recorded automatically, along with the patient's name. Users cannot go back to change any findings after it is entered and made permanent (refer to FIG. 3, section 98 and FIG. 5, section 125 “Are you finished?”). However, users can add data to files, noting that the additions may have the same date but will have a later time.

The final report will contain the items checked off at treatment, including the class findings noted, their point values, any comments programmed into it and defaulted options, or those added manually at treatment. The user will go to the REPORT MODULE ( refer to FIG. 1, box 65, and FIG. 2, select Option 2, day choice). List total point values achieved for each item per day: and press (enter)

They might see the following possible example, depending on which items were selected from the above algorithm:

Claudication (1 point)

Edema (1 point)

Absent dorsalis pedis pulse (2 points)

According to the Government algorithm for covered routine foot care, this combination would be acceptable for billing and payment. A pre-programmed message would appear: “This is probably a covered service for routine foot care, but please check the date of the last visit to be sure it was not earlier than 6 months”

The treating doctor would also see any other data they typed in under the “Comments” section of their PDA screen (refer to FIG. 3, section 90) when they saw the patient. This might include the anatomic locations of the various features, right, left foot, ankle, etc. It might also include treatment procedures that have been previously defaulted into the program, allowing the physician to print those as well. The date and name of the patient would automatically appear (refer to FIG. 3, section 89), as well as the time and date of selecting YES on the PDA, (refer to FIG. 3, section 98) indicating that “the user is finished.”

In another illustrative embodiment demonstrating the use with disparate data handling. These programming options illustrate the use of this program to handle disparate, unconnected data that in fact, Government connects together in a very specific manner. This invention will allow the user to simply carry his/her PDA to a nursing home and check off findings, and if they wish, program defaulted treatment options by using the default comments sections in this program.

To apply this to auditing previously completed chart notes, the process is simply reversed. The auditor goes through completed chart records, checks off findings (Worksheet Creation Module, box 45, FIG. 1) and prints whether the visit is covered according to Medicare law (refer to FIG. 1, box 65, and FIG. 2, choice 2, daily). This is a demonstration on how non-medically trained personnel could use this invention for successful, repeatable audits.

Further, this invention can be even used to grade auditors on their performance. To accomplish this, one would use the Auditor's Feedback Loops (refer to AUDITOR's PRINTED REPORTS, FIG. 1, box 95 to WORKSHEET CREATION MODULE, (refer to line 85 in FIG. 1 and also in FIG. 1, box 45, and AUDITOR's PREPARE THEIR OWN WORKSHEETS, FIG. 1 box 82, to WORKSHEET CREATION MODULE, FIG. 1, box 45 and lines 84) and some other more experienced auditors would audit the same medical records over again. The reports can be compared by a senior auditor for repeatability. This concept precisely demonstrates my “the circle of reliability” in numerical, statistical terms. If the results did not achieve repeatability, the student auditors might be exposed to additional training. This program will also define where they have “failed” and in exactly the cohorts that need more “work.” It then becomes a training and educational device, depending on how it is used.

This invention would not necessarily require a computer to accomplish the above uses. They could each be designated to paper entries, check-off lists and the use of adding machines to add and check totals. A complete paper template system could be constructed, and it would still be possible to audit and verify the “circle of reliability.”

This invention is not just a computer program. It is a logical, interconnected system, deliberately designed not to use multiple programming steps that would shield users from logical fallacies. But these can be added by programmers for specific applications.

As another example, the present invention may be useful in Evaluation and Management services, government's medical billing rules. Included are U.S. Government's EVALUATION AND MANAGEMENT SERVICES (abbreviation: “E and M”) algorithm for medical billing as arranged in the format of my invention. It is included to prove that the program is suitable for this algorithm as I have above claimed. It is one thing to “claim” that it will fit; quite another to actually show the point values and data streams. One of the implications of this is the way in which it condenses extraneous volume down to basics. The original 1997 DOCUMENTATION GUIDELINES FOR EVALUATION AND MANAGEMENT SERVICES, as published by Centers for Medicare & Medicaid Services, 7500 Security Boulevard, Baltimore Md. 21244-1850), contains 51 pages of explanations, commentary and examples. Quite unintentionally, this application becomes an excellent way to teach E and M Codes, further disclosing my contention that it is also a teaching tool. It should not be lost upon the reader that these numerical data distributions now enable the possibility for illuminating, gross statistical manipulation, as I also contend are available in my invention. The late great Symphonic composer, Jean Sibelius wrote his symphonies by taking small, short patterns, connecting and building. He spread those snippets into gigantic formats. Our goal is the opposite.

The point system disclosed was obtained by thoroughly studying the many pages of E and M rules and examples and assigning point values that allowed the various requirements to be fulfilled, in a sense, working “backward.” I reviewed the number of requirements for each section and their hierarchical values. Here is the result, a condensate of a little over three pages:

TEMPLATE FOR AUDITING AND DOCUMENTING EVALUATION AND MANAGEMENT CODES

I. DOCUMENTATION OF HISTORY (DH)

History of Present Illness

(HPI) Review of Systems (ROS) Past, Family and Social History (PFSH) Type of History

BRIEF (1 POINT)+N/A+N/A=PROBLEM FOCUSED (1 PT)

BRIEF (1 PT)+PROBLEM FOCUSED (2 PTS)+N/A=EXP. PROB. FOCUSED (3 PTS)

EXTENDED (4 PTS)+EXTENDED (4 PTS)+PERTINENT (3 PTS)=DETAILED (11 POINTS)

EXTENDED (4 PTS)+COMPLETE (5 PTS)+COMPLETE (5 PTS)=COMPREHENSICE (14 PTS)

SUMMARY OF POINT VALUES:

EVALUATION TOTALS FOR GROUPS:

A. BRIEF—1 POINT

B. PROBLEM FOCUSED—1 PT

C. PROBLEM PERTINENT—2 POINTS

D. DETAILED—3 PTS

E. PERTINENT—3 POINTS

F. EXPANDED PROBLEM FOCUSED—3 PTS

G. EXTENDED—4 POINTS

H. COMPLETE—5 POINTS

(Refer to the elements of examination below and add the relevant points)

II. CHIEF COMPLAINT (CC)

A. CHIEF COMPLAINT (CC—1 POINT)

B. EVALUATION TOTAL FOR THIS GROUP: BRIEF (1 PT)

III. HISTORY OF PRESENT ILLNESS (HPI)

A. LOCATION (1 PT)

B. QUALITY (1 PT)

C. SEVERITY (1 PT)

D. DURATION (1 PT)

E. TIMING (1 PT)

F. MODIFYING FACTORS (1 PT)

G. ASSOCIATED SIGNS AND SYMPTOMS (1 PT)

H. EVALUATION TOTALS FOR THIS GROUP:

1. BRIEF (UP TO 3 PTS)

2. EXTENDED (AT LEAST 4 PTS)

IV. REVIEW OF SYSTEMS (ROS)

CHOOSE POSITIVE RESONSES TO ISSUES TO MAKE POINT COUNT

A. CONSTITUTIONAL SYMPTOMS (fever, weight loss, etc.)—1 PT

B. EYES—1 PT

C. EAR, NOSE, THROAT—1 PT

D. CARDIOVASCULAR—1 PT

E. GASTRO-INTESTINAL—1 PT

F. RESPIRATORY—1 PT

G. GENITO-URINARY—1 PT

H. MUSCULO-SKELETAL—1 PT

I. INTEGUMENTARY/BREAST—1 PT

J. NEUROLOGIC—1 PT

K. ENDOCRINE—1 PT

L. ALLERGIC/IMMUNOLOGIC—1 PT

M. HEMATOLOGIC-LYMPTHATIC—PT

N. PSYCHIATRIC—1 PT (Refer also to counseling being more than 50% of patient encounter)

O. EVALUATION TOTALS FOR THIS GROUP:

1. PROBLEM PERTINENT (1-2 PTS)

2. COMPLETE (10 PTS+)

3. COMPREHENSIVE (11 PTS+)

V. PAST FAMILY, SOCIAL HISTORY (PFSH)

A. PAST HISTORY (illnesses, operations, injuries, treatments)—1 PT

B. FAMILY HISTORY (hereditary, predispositions, at risk scenarios—1 PT

C. SOCIAL HISTORY (age appropriate of past and current activities)—1 PT

D. EVALUATION TOTALS FOR THIS GROUP:

1. PERTINENT (1 PT)

2. COMPLETE (2 PTS)

VI. TIME FACTORS (TF) COUNSELING AND CO-ORDINATION OF CARE IS MORE THAN 50% OF THE PATIENT/FAMILY ENCOUNTER

EVALUATION TOTALS FOR THIS GROUP

1 HOUR—4 PTS

VII. PSYCHIATRIC MODULE (PM)

A. SPEECH DESCRIPTION—1 PT

B. THOUGHT PROCESSES—1 PT

C. ASSOCIATIVE PROCESSES—1 PT

D. ABNORMAL /PSYCHOTIC IDEATIONS—1 PT

E. JUDGEMENT—1 PT

F. ORIENTATION TO TIME AND PLACE—1 PT

G. RECENT/REMOTE MEMORY—1 PT

H. ATTENTION SPAN/CONCENTRATION—1 PT

I. LANGUAGE AND NAMING OBJECTS—1 PT

J. FUND OF KNOWLEDGE—1 PT

K. MOOD AND AFFECT—1 PT

L. EVALUATION TOTALS FOR THIS GROUP:

1. PROBLEM FOCUSED 1-5 PTS

2. EXPANDED PROBLEM FOCUSED 6-9 PTS

3. DETAILED 9-10 PTS

4. COMPLETE 10 +PTS

VIII. MEDICAL DECISION MAKING (MDM)

CHOOSE FROM: (estimate point stature per example)

A. Requesting advice of others—verify response—1 pt

B. Worsening or condition not responding as expected—1 pt

C. Contradictory tests and results—1 pt

D. Request old medical records—1 pt

E. Referral or decision for surgical or invasive procedure—1 pt

F. Significant morbidity potential—2 pts

G. Immediate risk of gangrene, fulminating multi-locus infection—4 pts

H. Severe electrolyte imbalance in compromised cardiac patient—4 pts

I. Meningitis, acute increase in intra-cranial pressure—5 pts

J. Cardiac tamponade, pericarditis, acute MI—5 pts

K. Immediate risk of death or true medical emergency—5 pts

L. Other examples can be added to this list

M. EVALUATION TOTALS FOR THIS GROUP:

1. MINIMAL—ONE IDENTIFIED PROBLEM 1 PT

2. LIMITED—TWO OR MORE SELF LIMITED PROBLEMS 2 PTS

3. MULTIPLE—MODERATE COMPLEXITY 34 PTS

4. EXTENSIVE—HIGH COMPLEXITY 5+POINTS

(It is obvious that the more complex the problem, the higher number of points. Use this chart as a “guide” to estimate others)

IX. TABLES OF RISK (TR)

A. MINIMAL—One self limited minor problem—1 pts

B. LOW

1. Two or more self limited or minor problems—2 pts

2. One stable chronic illness—2 pts

3. Acute uncomplicated illness or injury—2 pts

C. MODERATE

1. One or more Chronic lllness—3 pts

2. Undiagnosed new problem—3 pts

3. Acute illness with systemic symptoms—3 pts

4. Two or more stable, chronic illnesses—4 pts

5. Acute complicated injury—4 pts

D. HIGH

1. One or more chronic illnesses with severe exacerbations—5 pts

2. Acute or chronic illnesses or injuries that pose threat to Iife—5 pts

3. Serious trauma—5 pts

4. Abrupt change in neurological status—5 pts

In describing this embodiment, please note the POINT VALUES designated for each characteristic. They can be set up in the WORKSHEET CREATION MODULE, (refer to FIG. 1, box 45). Then, the user would select the REPORT MENU (refer to FIG. 1, box 65, and FIG. 2, programming option 7) to set up specific comments for various point ranges. The programming would proceed to allocate comments to the specific Government algorithm requirements as noted in the above summary. For example, in the TABLE OF RISK (TR), if the point total for a minor problem only equaled 1 pt, this program would designate it as “MINIMAL” (refer to FIG. 2, choice 7, “Attach this comment (field) to total points achieved from all items (chain together these specific item numbers).” That range would be between 0 and 2 points. The item numbers would appear as lists (refers to WORKSHEET CREATION MODULE, FIG. 1, box 45, see numerical attributes in box 45).

Thus this algorithm can be set up in much the same way as the above example for routine foot care, clearly demonstrating the program's ability to manage disparate, unconnected data streams in user defined hierarchies of values.

For simplification, the user just “removes” the data streams that don't often apply to them: the obvious fact for example that most professionals don't use the psychiatric section. Review of systems is commonly used since those tend to pay more, so practitioners will use that more. Auditors can program their own application screens in the Worksheet Module (FIG. 1, box 45, and FIG. 3) to suit the specialty they are auditing at the time (refer to REPORT MODULE, FIG. 1, box 65 and FIG. 2, and programming option 7 in FIG. 2 ). For the purpose of complete disclosure, and to provide proof of my statement that this invention can allocate and manage disparate data streams statistically, I herein disclose a complete hypothetical example using the Evaluation and Management algorithm:

Date: Jan. 1, 2004 Mr. Hardy Data is a 63 year old male who is a chronic cigarette smoker who presents with a very painful lower left leg that is impossible to stand on or be touched. He complains that this has been sore for about 5 years, but lately it has become impossible to walk on it for more than a few steps. He smells of tobacco use. His wife states that “he doesn't trust doctors and does not generally seek medical care.” He is employed as an auto-parts sales person and sits at his job. Lately he indicates he indicates that he has not been able to go to work because of the pain.

SELECTED ITEMS: HPI 1 PT (LOCATION), HPI 1 PT (SEVERITY), (HPI 1 PT), (MODIFYING FACTORS—CIGARETTES)

His wife assisted him into the examination room, and he is stressed and obviously in pain. His medications include His medications include Dilantin for occasional seizures which have been a minor problem for many years. He started taking the Dilantin after an auto accident that occurred when he was in his 30's and he subsequently started to suffer occasional seizures. He is not able to drive anymore however, due to this. He denies allergies to any medications. He indicates a history of trying to stop smoking but has never taken a “smoke-ender's” class or tried any nicotine substitutes. He says he learned smoking during the Viet Nam War, where he served. He is wearing slippers today and complains that after a few steps the pain becomes unbearable.

SELECTED ITEMS: (PFSH—1 PT) (CURRENT ACTIVITIES)

Upon examination we removed his slippers and requested he undress to shorts and tee shirt.

CHIEF COMPLAINT: Painful left lower leg, from pre-tibial area to distal, including the left foot

SELECTED ITEMS: (CC 1 PT)

PERTINENT HISTORY: Chronic smoker of at least 40 years. Two packs daily, inability to walk even 5 steps on the left side without stopping in agony. There is a history of difficulty walking and pain in the lower left leg for at least 5 years, for which the patient has not sought any medical care or examination.

SELECTED ITEMS: (HPI 1 PT) (DURATION)

ALLERGIES: None reported

SELECTED ITEMS: NONE REPORTED

MEDICATIONS: Dilantin 300 mgs extended release, i daily

SELECTED ITEMS: None reported

PFSH (1 PT) (AT RISK SCENARIOS, UNREGULATED DILATIN USE)

PAST HOSPITALIZATIONS: History of gall bladder surgery 22 years ago, none since

SELECTED ITEMS: (PFSH 1 PT)

PERTINENT FAMILY HISTORY: Father died of unexpected heart attack at age 57, mother dead from CA at age 72

SELECTED ITEMS: (PFSH 1 PT)

PROSTHESES: None

PERTINENT OTHER NOTES: Patient is unresponsive to the issue of Dilantin blood levels and how he was able to get prescriptions for a medication that usually requires periodic blood levels. It is possible that the patient orders this on the Internet, and may still drive, but this is just conjecture. He does not indicate any seizure, grand mal or petite mal for over 15 years. The patient is generally an unresponsive historian. Several times during the examination there was a dry hacking cough noted, but it did not seem to be productive. The patient carries himself with his chest inwards and struggles for the next breath.

SELECTED ITEMS: (PM 1 PT)(JUDGMENT, MOOD AND AFFECT)

PHYSICAL EXAMINATION

BP: 155/90 PULSE: 110 TEMP: 98.9 RESP: 35 and grasping

SELECTED ITEMS: (ROS 1 PT)

NORMAL: (MARK X) SIGNIFICANT FINDINGS

EENT: Eyes dry and crusted, slight sclera jaundice bilaterally, ear canal not visible from cerumen blockage, non-tender. Nose has some rhinophyma and capillary fragility externally and is clear in the nares bilaterally. Throat is slightly red, epiglottis discolored yellow and the patient has foul breath, teeth are severely stained and gums appear to be somewhat hypertrophic, an expected finding in the presence of poor dental care and heavy cigarette smoking. (Dilantin can cause hypertrophic gingivitis) The rhinophyma is suggestive of a history of alcohol abuse, which the patient vociferously denies. There are no masses or changes in the midline of the trachea or cricoid cartilage and pharynx. The trachea is midline and not distorted to either side in the neck.

SELECTED ITEMS: (ROS—1 PT) (EYES) (ROS—1 PT) (ENT)

HEART: Moderate tachycardia, regular sinus rhythm, no irregularities or premature ventricular contractions to auscultation

SELECTED ITEMS: (ROS—1 PT) (CARDIOVASCULAR)

LUNGS: They are absent of rales or rhonchi bilaterally but there are definite rib cage changes characteristic of impending emphysema

SELECTED ITEMS:

(ROS—1 PT) (RESPIRATORY)

ABDOMEN: The abdomen is non-tender and obese. There appears to be a possible non-tender mass in the midline of the abdomen that has a different sound to percussion than the localized tissue.

SELECTED ITEMS: (ROS—1 PT) (GI)

ENDOCRINE: The patient denies diabetes. There is no polydipsia, polyuria or polyphagia.

SELECTED ITEMS—NONE

EXTREMITIES: Upon examination the dorsalis pedis and posterior tibial pulses are absent bilaterally to palpation. The left foot is cyanotic and cold. The patient is unable to tolerate any direct palpation of the dorsal or plantar areas of the left foot. The femoral arteries are not palpable in either groin. Actually at this point, the right foot and leg are also cyanotic, but not as much as the left. The skin on both legs is cracked, dry and there appears to be little or no substrate fat tissue under the skin on either side.

SELECTED ITEMS: (ROS—1 PT)

Upon attempting to walk the patient grimaces in pain and refuses to cooperate with attempted ambulation. The toenails are thickened and fungoused bilaterally and they have tom the socks. It is possible they have not been trimmed in over a year. There is a small ulceration between the 4^{th} and 5^{th} toes left foot that is dry. The patient is unable to tolerate closer examination of this lesion in our attempt to reflect the toes slightly apart. There is no fat pad under the metatarsal heads of both feet to speak of.

SELECTED ITEMS: (ROS—1 PT) (INTEGUMENTARY AND NAILS)

There are no venous occlusive signs or swelling in either ankle or foot. There are no ulcerations on either malleoli.

MUSCULOSKEL: There are no signs of fracture or dislocation in the arms or legs.

NEURO: The cranial nerves are intact and the patient is able to move his face and eyes appropriately upon request. He is able to extrude his tongue forward without medial or lateral display. The distal arm reflexes are intact and equal. The patellar reflex on the left side is absent; the right is 2+/4

Cremasteric reflex is within normal limits

Attempts were made to locate areas of loss of sensation on both lower extremities with vibratory and pin prick. The patient is not cooperative in this regard. The medial malleoli to distal on the left side have no reaction or sensation to pin prick of the skin, which seems somewhat out of character for such severe Claudication and rest pain. The right side is normal to pin prick and vibratory sensation with a tuning fork. The left side has diminished vibratory sense distal to the medial and lateral malleoli.

SELECTED ITEMS: (ROS—1 PT) (NEUROLOGIC)

RECTAL: After some argument on the part of the patient, he submitted to digital examination of the prostate and rectum. The prostate was significantly enlarged, but no nodularity lumps or irregularity was palpated. The patient has several small external hemorrhoids. A stool test for occult blood was performed, which was negative.

SELECTED ITEMS: (ROS 1 PT)

PELVIC: Upon examination the testicles are normal and no nodularity was noted. There are no signs of rupture or weakness in associated abdominal musculature.

LYMPH: There are no nodules in the neck, axilla groin or popliteal spaces palpable.

IMPRESSIONS:

1. Severe intermittent Claudication of the left lower extremity (TR-1 PT)

2. Pre-gangrenous changes of the left foot and ankle (TR-4 PTS)

3. Possible abdominal aneurysm descending aorta (TR-3 PTS)

4. Emphysema and COPD (TR-1 PT)

5. Moderate obesity

6. Rest pain (TR-1 PT)

7. Ulceration between 4^{th} and 5^{th} toe left foot (TR-1 PT)

8. Moderate tachycardia (TR-1 PT)

9. Gingival hypertrophy secondary to uncontrolled and unmonitored Dilantin use

10. Probable complete obstruction of the femoral artery on the left side, with little or no run-off

11. Probable history of alcohol abuse and possible active liver failure (TR—2 PTS)

12. Obstreperous attitude and difficulty in answering history suggests dementia, but the issue of internet usage to order Dilantin calls that into question. Perhaps his wife/friend does it for him. In any case, patient and his wife are not responsive to that issue. (PM-1 PT)

13. Hospitalize immediately (MDM-2 PTS)

14. Consult arranged for podiatrist and vascular surgeon on lower extremities (MDM—2 PTS)

15. Plan detailed laboratory and possible invasive procedures to deal with impending liver failure, biopsy and possible gangrene. (MDM—2 PTS)

TABLE OF RISK (TR) HIGH, 5 POINTS OR MORE, ACUTE OR CHRONIC ILLNESS THAT POSE THREAT TO LIFE

REPORT AND TALLY:

HPI=4 PTS=EXTENDED (HISTORY OF PRESENT ILLNES)

PFSH=3 PTS=COMPLETE (PAST, FAMILY AND SOCIAL HISTORY)

PM=1 PT=PROBLEM FOCUSED (PSYCHIATRIC MODULE)

ROS=10 PTS=COMPLETE (REVIEW OF SYSTEMS)

MDM=6 POINTS=HIGH (MEDICAL DECISION MAKING)

TR=14 PTS=HIGH (TABLE OF RISK)

After these data are accumulated, they could be used for a large variety of purposes, from statistical uses to determining the fees that should be charged, to proving that the services justified their fee in event of an audit.

In another illustrative use, educators can use this invention in a number of ways, including negotiation training and definition of types, resolution of disagreements, anger management, behavioral modification and the teaching of history by actually involving students in a living process. That example will be described here:

THE WAR BETWEEN THE STATES

The subtitle of this project would be: “Can evil (slavery) be eradicated without hostilities?” Obviously that did not happen. But it would be very interesting to place students into Focus Groups using this program to set up hierarchical lists of demands of both sides. For example, according to the secession of Texas from the Union in Feb. 2, 1861, here is partial list of some of their complaints that could be transcribed to hierarchical patterns by the students representing the State of Texas: (All direct quotes from the document entitled: A Declaration of the Causes which Impel the State of Texas to Secede from the Federal Union) Students representing the State of Texas using this program: (refer to FIG. 1, SUB-CHOICE CATEGORIES, box 30, choice B, and FIG. 1, VALUE ASSIGNMENT MODULE, FIG. 1, box 35, choices as designated)

“. . . Texas seceded to insure her welfare, insure domestic tranquility and secure more substantially the blessings of peace and liberty to her people (?pt value)

“. . . by violence and mob law, to usurp the possession of the same (Texas) as exclusively the property of the Northern States” (?pt value)

“. . . have deliberately, directly or indirectly violated the 3rd clause of the 2nd section of the 4th article [the fugitive slave clause] of the federal constitution, and laws passed in pursuance thereof; thereby annulling a material provision of the compact, designed by its framers to perpetuate the amity between the members of the confederacy and to secure the rights of the slave-holding” (?pt value)

“. . . all the non-slave-holding States, in violation of that good faith and comity which should exist between entirely distinct nations, the people have formed themselves into a great sectional party, now strong enough in numbers to control the affairs of each of those States, based upon an unnatural feeling of hostility to these Southern States and their beneficent and patriarchal system of African slavery,” (?pt value) Etc.

Students representing the North using this program: (material adopted entirely from the Emancipation Proclamation, issued by President Abraham Lincoln, Jan. 1, 1863) (refer to FIG. 1, SUB-CHOICE CATEGORIES, box 30, choice B and VALUE ASSSIGNMENT MODULE, FIG. 1, box 35, choice as designated)

“. . . That on the first day of January, in the year of our Lord one thousand eight hundred and sixty-three, all persons held as slaves within any State or designated part of a State, the people whereof shall then be in rebellion against the United States, shall be then, thenceforward, and forever free (?pt value)

. . . “And by virtue of the power, and for the purpose aforesaid, I do order and declare that all persons held as slaves within said designated States, and parts of States, are, and henceforward shall be free; and that the Executive government of the United States, including the military and naval authorities thereof, will recognize and maintain the freedom of said persons. (?pt value)

“. . . Now, therefore I, Abraham Lincoln, President of the United States, by virtue of the power in me vested as Commander-in-Chief, of the Army and Navy of the United States in time of actual armed rebellion against the authority and government of the United States, and as a fit and necessary war measure for suppressing said rebellion, do, on this first day of January, in the year of our Lord one thousand eight hundred and sixty-three, and in accordance with my purpose so to do publicly proclaimed for the full period of one hundred days, from the day first above mentioned, order and designate as the States and parts of States wherein the people thereof respectively, are this day in rebellion against the United States, the following, to wit (?pt value) Etc.

The students would break into focus groups to do Collective Bargaining, and try to find ways to prevent hostilities from occurring. Suggestions might include methods to financially compensate slave holders, soften states rights in other issues, provide the South a subsidized higher price for cotton, allow the South to maintain their own militia, etc. (refer to FIG. 1, box 65, and FIG. 2, REPORT PRINTING MODULE, choice 1) Students would attempt to develop Worksheets (refer to FIG. 1, box 45) with those characteristics using this invention and assign numerical point values to those worksheets (refer to FIG. 1, box 35). They would then download them into PDA's (refer to FIG. 1, line 105) and try to develop an “auditors program” (refer to AUDITOR's REGISTRATION MODULE, FIG. 1, box 75 and FIG. 4) to monitor the Worksheets. (refer to FIG. 1, box 45) The auditors would serve during the collective bargaining to try to maintain order and assist development of the Worksheets, using the published rules that come with this invention (refer to FIG. 1, box 65 and FIG. 2, choice 1). Using the benefit of hindsight, auditors could bring in some of Mathew Brady's photographs of battles and war dead to remind those present what this War actually meant.

Other historical references could be used along with this program, and auditors could do their own separate historical research in efforts to obtain a compromise. Students would be required to use actual historical references to complete and take part in this project, as in the above examples. This inventor can hardly think of a more involving, active experience to learn about the War Between the States.

During this process, the educators could stand aside and allow real communication to occur. This invention will require that students follow a designated non-linear negotiation format. The educator could also assign one focus group to use a standard linear negotiation format and everyone could see what they produce, compared to non-linear use of this program.

This project could also be done without a computer. The process involves human interaction, listening to preferences and negotiating them according to historical antecedents. Using the closed loop (refer to FIG. 1, lines 84, 85 and 86, for Auditors and FIG. 1, line 120 for Users) architecture, it is possible for students to step into the place of others and learn how they might feel if they were in “another place.” Requiring some students to serve as auditors in a historical context where none really existed teaches students the value of verification and monitoring in a way that perhaps, nothing else would.

In a further illustrative use involving education, an automated examination procedure may be employed. A school district in California was given a grant by a wealthy donor. Since they already had computers for most students, they decided to purchase Personal Data Assistants PDA's for examinations and other teaching. Many students had them, but since they can easily be programmed with “extraneous material” that might assist some students in the examinations, only the units supplied by the teacher for the exam that day could be used. The teacher in the World History class likes to give the typical examination that most of us have had throughout our education many times: the multiple choice exam. The subject for the examination is World War II:

1. Most people acknowledge that approximately these many Jews were murdered by Hitler and the Nazis?

a. 2 million

b. 4 million

c. 6 million (the correct answer gets 10 pts)

d. 10 million

e. 13 million

2. The correct date that the Japanese bombed Pearl Harbor was:

a. Dec. 20, 1942

b. Jun. 6, 1944

c. Mar. 31, 1943

d. Dec. 7, 1941 (the correct answer gets 10 pts)

e. None of the above

3. Who decided on the exact date that D-Day would occur?

a. Winston Churchill

b. Franklin D. Roosevelt

c. Dwight Eisenhower (the correct answer gets 10 pts)

d. George Marshall

e. George Patton

4. etc.

The examination can be given in a number of ways. It is possible to download each question into each PDA (refer to FIG. 1, line 105), and from the central computer, with a, b, c, d, e choices for each question. Every wrong answer gets 0 points. The correct choice gets the number of points the instructor desires, thereby controlling the “weight” of each question according to teachers' choice. It is also possible to pass out papers containing the questions and just leave the PDA's set out the same way, with list of numbered questions and a, b, c, d, e choices. Each time an exam is given; the correct choice is programmed into the central computer and given the number of points desired. (refer to FIG. 1, VALUE ASSIGNMENT MODULE, FIG. 1, box 35, WISHLIST CREATION MODULE, box 50) They are then downloaded into each PDA, (refer to FIG. 1, line 105). Teachers could enlist students to download the PDA's just before the test, since the downloading is just a matter of plugging in a transfer cable into them and clicking a download button. It's a little tedious, but 30 PDA's should be able to be downloaded in about 15 or less minutes. Uploading the exams into the central computer would take bout the same time. The central computer would print the grades in a few minutes (refer to FIG. 1, REPORT MODULE, box 65 and FIG. 2, Choice 2, option daily). If the teacher preferred, each student could simply stand in line and upload their own PDA when they are ready to turn them in. It would also be possible to install the entire test question into the PDA. As PDA's get cheaper and more powerful, it should not be necessary to upload and download, since they could contain the entire program in them. Scoring the examination in this invention: The user would go to the REPORT MENU (refer to FIG. 1, box 65 and FIG. 2, option 7). This option allows them to set a grade to a range of points achieved on the exam. For example, they may select a point range of 80-100 points to print out as an “A” grade. This is really very accessible programming. The users could select any ranges they wanted.

If teachers wished, it is possible to program this invention to develop statistical cohorts based upon answers given, even if they are incorrect. For example, the program can print all point responses for each answer (refer to FIG. 1, REPORT MODULE, box 65, and FIG. 2, option 5 daily). The teacher cold install negative point values to incorrect answers, thereby removing credit from the total for wrong answers. There are other ways to program this invention. Educators might decide to change the actual code in the program to suit specific testing needs, changing the way the statistical data is collected to suit them. The basic design and function of the program would remain as it was originally intended, but the statistical handling of cohorts of data might be completely personal to the needs of the user. Even if the original program did not suit users, there is little difficulty to hire a programmer to change it, as long as it is authorized.

Grading has been done manually for years, frequently by simply placing a “key” cutout over the papers handed in by the students. A computerized method might be more accurate, since it is only human nature to get a bit tired and sloppy when doing repetitive behaviors, especially for large numbers of test takers.

Another illustration using the present invention involves a physical trainer. A physical trainer often likes to examine their clients and run them through a series of tests of various kinds to evaluate their present conditioning level and design a tailor-made program for each client. The scenario usually goes like this:

The trainer will first interview their new client, possibly weigh them, and some do a body-fat analysis. Then they often have their clients run through a series of standardized brief exercises to determine their heart rate and fitness level at various degrees of exertion. After this pattern is complete they may also discuss food and dietary habits. By the time they are finished, the physical trainer or therapist has a clear idea of the program they wish to present.

Repetitive use of exercise and nutritional programs is critical to their clients' successful life-changing progress. As such it fits perfectly within the boundaries of this invention. The physical trainer will introduce his/her client to the Personal Digital Assistant. Together they will sit down and develop a Worksheet (refer to FIG. 1 for WORKSHEET CREATION MODULE, box 45, and FIG. 1 for VALUE ASSIGNMENT MODULE, box 35, select option C) that will be downloaded into the PDA (refer to FIG. 1, line 105). It might look like this:

Avoid all meat, dairy and eggs, check off those days here (5 pts)

Run 2 miles at 4.8 mph at setting number 1 elevation on the treadmill, check off dates done here (5 pts)

10 chin pulls on the horizontal bar (2 pts)

10 abdominal crunches at 501b setting (2 pts)

Record your weight at morning rising every other day and write the results in the comment section (2 pts)

10 prone leg curls with 20lbs (1 pt)

Sweet day. Any use of high calorie or fat item, with more than 10 gms of saturated fat (−8 pts) check here each time

The trainer will upload the data each week at their regular appointment and create reports to share the results. A report might look like this: (refer to FIG. 1, Upload finished Worksheets, (refer to FIG. 1, box 59 and REPORT MODULE, FIG. 1, box 65 and FIG. 2, choice 2, weekly).

10 prone leg curls with 20lbs—60 pts total

10 chin pulls on the horizontal bar 2 pts—0 pts total

10 abdominal crunches at 50 lb setting 2 pts—40 pts total

Avoid all meat, dairy and eggs, check off those days here (5 pts) 10 pts total

Run 2 miles at 4.8 mph at setting number 1 elevation on the treadmill, check off dates done here 5 pts—25 pts. total

Record your weight at morning rising every other day and write the results in the comment section 2 pts—4 points total

Sweet day. Any use of high calorie or fat item, with more than 10 gms of saturated fat (−8 pts) check here each time −32 pts

Grand total points=147

A brief evaluation of this demonstrates that the client tried to run quite a bit to burn off those high fat calories. No weight was lost this week; but none was gained either. The client is still not eating properly, and in order to really change habits this person may need some nutrition and food substitution counseling. (refer to FIG. 1, REPORT MODULE, and FIG. 2, option 1) This program has clearly shown where new efforts should be directed. This is the first week so nobody expects high volumes of exercise, which can cause burn out and excessive muscle soreness. But the trainer expects more improvement soon. The trainer and his/her client will then refer to some substitution food behaviors included with this program. (refer to FIG. 1, WHAT DO YOU WANT, box 26, and Sub-Choice Categories, box 30, choice A) The client will receive a printed copy of their report at the end of the session.

In a general illustrative use involving payment, auditing and refunds, Payers are paying to optimize a total system and keep it running. Receivers provide services to the payer(s) to keep the system running. Auditors function to both re-assure payers that their funds are being used as contracted and receivers to be reassured that they have received appropriate payment for their services. This Modeling System shows how this invention can serve as a negotiating tool to allow payers, receivers and auditors to come to agreement. Later it will serve as a model for reassuring all parties that the system is operating as agreed. Although this is set up as a medical service and audit model, there is no reason why it cannot be generalized to other similar constructs where fee for service and defined issues for payment can be (and should be) codified.

Gaming is described as the molding of attributes of a system to encourage a particular result. Payers are concerned about releasing information that might result in “gaming” by the receivers, which might cause receivers to obtain “excess” compensation. They are reluctant to supply information that might allow this. Receivers are held legally or contractually to follow rules that are not always completely disclosed. I like to describe this as the “code dance.” Providers take a step “up” to select codes that pay better. Payers take a step “down” to force providers to not use those codes, or deliberately re-assign them to cost less money. The purpose of this modeling system is to allow payers to completely disclose and receivers to be held to supply services as agreed in advance. The only way this will ever get done is with a non-linear system with integrated verification.

Payers by definition are more powerful than receivers. Yet, payers have a need for service providers if their system is expected to operate and maintain its integrity. Nobody can do everything themselves, even payers. Eventually people have to be hired and paid. Payers have the right to refuse payment based upon this model. Receivers have the right to not take part in the program, but if they don't, they cannot demand payment from the payer. Government might choose, as a basis for assuring the “common good” that receivers not have the ability to go to other payers instead. However, this should be rare and required only for the “common good.”

Payers, receivers and auditors are all part of the negotiating model. They will meet in negotiations together. This time is described as “Table Time.” The purpose of this model is to obtain agreement between all parties prior to the first payment made for services, if possible.

The functions for auditors are to develop mathematical models that prove payers received the services they contracted, and prove that receivers obtained the compensation they contracted for maintenance of the integrity of the total system. Good auditors' data allows both sides to model and evaluate the effectiveness of the total system of payment and reimbursement. Developed data might cause either or both parties to request a return to “The Table” for additional negotiations.

Nothing in this model is intended to preclude or remove “normal accounting” principals, their function, design or implementation. Rather, they are considered “complimentary” to this modeling system and will assist its successful function.

Negotiated agreements “At the Table” shall have the strength of a “Contract” between the parties. If a contract is broken by any of the involved parties, ordinary “Contract law” as developed and maintained in the legal system can be triggered. Nothing in this negotiation and modeling system is implied to preclude or remove “normal contract law,” or to provide legal advice or practice law. As always, it is strongly advised to seek legal advice prior to accepting or signing any agreements or contracts.

Penalty charges for punitive purposes are not included in this Modeling System, but could be.

Irrevocable damage that severely affects the operation that the payers wish to support (e.g. heart attack versus minor sprain) gets the highest grade. Inconsequential and gratuitous issues get the lowest grade. The weight of each of these items, and their position on the continuum, is decided “at the table” by the negotiating participants.

The Ranges of Covered (services the payer is willing to pay for) are scored “at the table” by the negotiating participants. The rates of payment for specific services are not covered in this Model.

Payers want to see the total system operating properly. Therefore the attributes are set up as follows:

Data points: Each attribute is called a “Data point.”

Most Important: Most important attributes to system function, life-safety, survival of system integrity. These attributes receive the most points.

In between: Comprises the continuum between most and least important

Least Important: The least important attributes to system function, life-safety or survival of system integrity. Those receive the least or no points.

Total Attributes: The total number of attributes from the greatest to the least is added together.

Data point(s) hierarchy: Defines where each data point stands in the total hierarchy

Payment Triggers: Payers and receivers agree on what constitutes payment triggers based upon previously agreed computations of the percentage of total attributes their submission for payment qualifies for each service. This will also define frequency of service submissions permissible as agreed “At the Table.”

Audit Triggers:

Payers will periodically seek proof (audit) of the data points calculations made by receivers in their quest for payments. The frequency of audits will be agreed upon in advance, “At the Table” based upon the data developed by either party or history of cooperation. Both payers and receivers will be granted the right to obtain audits.

There are two kinds of audits: Periodic and requested. Periodic audits are designated in the agreement in advance. Requested audits are done when each or both parties make a request for one.

Audit Levels:

Specific levels of audits can be requested by either party. Audits can include determination of sufficiency of documentation by receivers, determination of adequacy of payment by receivers and/or both. Higher level audits might define adequacy of the entire model and trigger a renegotiating of Data point hierarchies. That is called “returning to the table.”

Reimbursement Triggers:

These occur when an audit reveals that a particular receiver does not have sufficient points in their request for payment to justify the payment level they have submitted as previously agreed by all parties “At the Table.” They may also be triggered by “excessive” submissions for payment based upon inadequate Data points in their records. This is called “Over-use.”

Removal from the System:

This occurs when a service provider exceeds the boundaries defined and agreed in advance “At the Table.” Threshold triggers for Removal from the System shall be defined and agreed by the negotiators in advance. Nothing in this program shall preclude or remove obligations of the legal system to exercise its normal and typical function, nor will it excuse payers, receivers or auditors from their ordinary legal obligations.

Government Systems:

Government has the ability to design and set up systems using this program to define their own parameters for payment. This is due to the permanent differential in status between Government and those who provide services to Government or Government clients. We already described government negotiations as asymmetric. None of us has the power of government. Therefore negotiations are unequal, Socratic and at least in this model, non-linear. But “input and suggestions” from the receivers surely will encourage better operation of the system, and contribute to data collection and effective audit functions. Government should make a “good faith effort” to inform those they pay of Government's own Data Point requirements in advance of audits and prosecutions. After all, they are “Big Brother.”

The best way to explain the Modeling System is to actually set up a Model using it:

Most Important: Anything that could cause the “death” of the system. A clogged coronary artery results in an acute and emergent heart attack that could cause the death of the individual.

Least Important: The patient suffered a small contusion to their thigh striking a table as they fell during the heart attack.

In between: The patient has chronic hypertension and other non-contributing medical problems.

1. The patient had a serious heart attack. (10 points)

2. The patient has chronic hypertension and other “non-contributing” medical problems not counted in the data point's hierarchy. (1 point for each)

3. The patient suffered a small contusion to their thigh, which they are not even aware of. (1 point)

Total number of Data points: 3

Relative Value of Most important data point(s) 10

Relative Value of Middle-liers 1

Relative Value of Least Important data points 1

Total Relative value of total Data points 12

Data on Need for treatment of heart attack 10 out of 12 pts

Data on Need for treatment of least important 1 out of 12 pts

Payment Trigger:

10 out of 12 points indicates that this treatment date will be honored and paid by the payer.

Denial Trigger:

1 out of 12 points indicates that treatment for this condition is either denied or “simply” included in the cost for the life threatening condition, which has a higher point value

Numbers of Data Points:

The number of data points in a particular situation is included to provide auditors with an “overview of its relative complexity. It is important for an auditor to understand the complications involved in any situation prior to passing judgment on it.

Audit Trigger:

Auditors looking at this chart note will look to see if the data is supportive of a score of 10 out of 12 points. The auditor would look for “place of service” data to support this, like an emergency room location, etc. The supplier of the service is entitled to request an audit to re-assert their contention that this should be a “covered service.” Obviously this is a simple case. But even in more complex issues, it is not difficult for auditors to simply add up the data points to test that particular claim for payment. This takes away the potential for audit confusion, and turns attributes into data collection that can be used for statistical models.

Computer programs are frequently connected to each other, thereby transforming the attributes of each far beyond each unit's individual utility and value. This is true with this program as well. An example of this would be the management of data derived from this invention, which depending on the number of participants involved, could be considerable. My invention is not designed to handle very large amounts of data, nor was it intended for that purpose. The data available from it might need to be further collated, clarified, examined and elucidated. Even a slight increase in the number of participants could generate enormous volumes. There is no reason why that data cannot be connected with a large data base program to develop and clarify the statistical material derived. An example of this would reside in the following, final example of the use of this invention:

Illustrating the use of the present invention, using technology to try to negotiate a lasting end to the Israeli/Palestinian is presently untried. Negotiators have been chosen by the leaders of both peoples, in the futile hopes that they could craft an agreement. This example clearly demonstrates the limitations of linear modeled negotiations. It is possible for the Israelis to insist that the Palestinians were never interested in peace, rather, only destroying Israel. It is possible for the Palestinians to say that Israel really wants to occupy the Palestinian territories that Palestinians feel were stolen from them in 1948 and even earlier. Both parties probably agree that monitoring the process is the key to successful negotiation. The intended purpose of the method proposed below is to involve hundreds, if not thousands of Israelis and Palestinians in the peace process, along with their perhaps reluctant leaders. Any algorithm would be greatly aided by ease in translation into Arabic/Hebrew/English as necessary. This program could be easily translated.

The War between the Israelis and the Palestinians is circular. Israelis penetrate Palestinian territories to find and defeat terrorists; and Palestinian terrorists penetrate Israel to perpetrate suicide bombings against civilians. In an excruciating irony, Israelis have been forced into a quasi-occupying force required for their own survival after being the victims of an occupying force that very nearly resulted in their extinction. This is not intended to imply any connection between the Jews and Nazis, but simply to point out a circular relationship. Just before Israel was recognized by the U.N, some of its own freedom fighters exercised terrorist techniques against the British. Now they are themselves victims of it.

The circle persists. Radical Arabs detest the United States military “occupation” on Arab land (Saudi Arabia). They institute suicide and terrorist attacks against the United States to get the U.S. out of their lands. Then, the U.S. strengthens their presence in Arab lands to protect World oil resources and supply (including for Europe and the Far East) and to even protect Arabs from themselves (the 1990 Gulf War). Arabs and Jews have occupied various geographical areas of the Middle East for over two-thousand years. Sometimes they were at war; other times there were large expanses of peace and mutual trade. The very nature of tribal territories and warlordism is circular. Because of the lack of natural resources in an area and the lack of rule of law, warlords take over a geographical area. Tribal battles go in circular fashion back and forth for centuries.

A negotiator who goes here is stepping into a segment of the circumference of a circle. They are attempting to manage a disconnected segment of an arc. There is a poetic logic that improvements in modern satellite photography resulted in the first U.S./Soviet Nuclear Test Ban Treaty. Those satellites go “around the World.” It is not surprising that linear logic applied to non-linear problems fail. When they succeed, it is often because outside forces overcome one side entirely. But that does not mean the vanquished side will remain quiescent. Unless there is a means to supply the vanquished side with autonomy, a growing economy and a construct for self governance, they will eventually revolt and enter a place in the circle again.

This is the logic behind the applicability of this invention to the War between the Israelis and Palestinians. When it is used and a user steps into it, they are stepping into a circle. The simplicity of the program is highly deceptive. It is capable of amassing enormous amounts of data which the inventor feels can be very reliable because of its repeating features. Users know that their contributions can be traced back to them in both date and time. Combined in this circle is a living, moving system of new concept development, statistical reporting and verification, all occurring concomitantly. This is a concept based solution, not in any way dependent on leaders' charisma, ego, wishes or hopes.

Linear negotiations might include the following Focus Groups:

Water rights for Palestinians

Location of detainment center for violent terrorists

Committee for the statistical evaluation of auditors' reports

Re-education development program for anti-hatred teaching

Definition of temporal levels of achievement of Worksheets

Worker transportation between each side

Humanitarian transfers

Computer program oversight and liaison committee

New Workgroup definition committee assignment group

Auditor evaluation Committee

Statistical evaluation Committee

Worker transportation into Israeli territories

Non-linear negotiations might include the following Focus Groups:

Arrest program for detaining violent Palestinians versus the Israeli withdrawal program

Auditor Selection by Palestinians versus Israelis

Policing of illicit weapons transfers from neighboring countries

Occupied territory settlement withdrawal policy

Definition of the Borders of the Palestinian State

Time strategy for recognition of the Palestinian State by Israel

New terrorist attack reaction committee

Definition of temporal levels of achievement of Worksheets

Re-education of violence training in Palestinian Schools

Reparations

The flow of the Focus Groups would be to follow the program's screens, connecting the four aspects of:

1. Identification and quantification of goals and desires, arranging them into hierarchies and assigning values to each (refer to FIG. 1, SUB-CHOICE, box 30, option B and FIG. 1, VALUE ASSIGNMENT MODULE, box 35, user designated option)

2. Identification, classification, discussion and learning about negotiation techniques (refer to FIG. 1, REPORT MODULE, box 65, and FIG. 2, REPORT MENU, option 1)

3. Negotiation and redefining each participant's tasks and arranging them into hierarchies, and assigning values to each (refer to FIG. 1, SUB-CHOICE MODULE, box 30, either option and FIG. 1, VALUE ASSIGNMENT MODULE, box 35, any choice, and FIG. 1, WORKSHEET CREATION MODULE, FIG. 1, box 45, user designated choices)

4. Task performance on a calendar and temporal basis which cannot be changed after it is entered, with statistical report generation (FIG. 1, to PDA, line 105, and FIG. 1, UPLOAD FINISHED WORKSHEETS, box 59, and FIG. 1 Hand entry, line 115)

Verification, “overlapping” audit and statistical recording on a calendar and temporal basis which cannot be changed after it is entered (refer to FIG. 1, using feedback loop from AUDITOR's PREPARE THEIR OWN WORKSHEETS, (refer to box 87, FIG. 1), FOR AUDITS TO WORKSHEET CREATION MODULE, (refer to FIG. 1, line 84) AND AUDITOR's PRINTED REPORTS TO WORKSHEET CREATION MODULE, (refer to FIG. 1, line 85 and 86), AND USER's FEEDBACK LOOP FROM UPLOAD FINISHED WORKSHEETS BACK TO WORKSHEET CREATION MODULE FOR NEW WORKSHEETS, (refer to FIG. 1, line 120, and box 59, FIG. 1)

5. Back to step 1 for each participant and auditors (refer to FIG. 1, lines 120, and 86)

Users of the program are required to make their entries, being aware that they will be registered permanently, cannot be changed once entered, and registered as to date and time. (refer to FIG. 5, section 125, and FIG. 3, section 98) Participants will understand that their performance will be audited, although they may not be certain ahead of time exactly what will be, and that everyone's performance in the program can be numerically graded. (refer to FIG. 1, box 65, and FIG. 2, REPORT MODULE, user designated, choice 7). Because of its recording characteristics the computerized embodiment can be traced to person, date and time.

Model Wishlists:

I. ISRAELIS:

No more terrorism

Free trade with the Palestinians

Free access to Holy sites

Water rights

No threat to Israel from Palestinians

Control Hamas and Hezbollah

Arrest terrorists and keep them away from Israelis and Jews

Want Palestinians and Arabs to work in Israel

Want other Arab states to accept more Palestinians in their lands

Want other Arab states to assist Palestinians financially

Want other Arab states to stop supporting terrorism against Israel

Want Arab and European hatred against Jews and Israel to stop

Want a viable peace process with leaders they can trust

Want free exchange of goods and services between the two states

Want to live in peace with Arabs and Palestinians

Want to keep Jerusalem as the Capital of Israel

Want safe, secure borders

Want normalized relations with all Arab states

Create your own

II. PALESTINIANS:

Establish Palestinian State

Free trade with Israelis

Israelis allow Palestinians into Israel to work

Allow access to goods and services

Water rights

Sewage rights

Open borders or at least easier access

Remove all Israelis from the occupied territories

Want other Arab states to stop treating Palestinians as pawns in the battle against Israelis

Want better leadership

Want to stop corruption in Palestinian leadership

Want the Israelis to stop attacking occupied territories and killing innocent people during those attacks

Want the United States to stop supporting Israel against Palestinians

Create your own

III. PALESTINIAN AND ISLAMIC EXTREMISTS:

Destroy Israel and Jews

Limit or stop American Assistance to Israel and Jews

Remove America and Israel from Islamic Holy places

Limit American cultural, financial and geographic imperialism against Islam

Destroy the Israeli state as an entity

Kill the entire ruling Saudi family

Return to Ancient, pure Islam

Remove America, but allow American cigarettes to continue to be manufactured and distributed free to Arab Countries

Remove all moderate Arab rulers and Countries

Stop teaching American loose moral values and blasphemy

Stop access to all Western TV in Islamic Countries

Establish conservative Islamic Maddrassas in all Western Countries

Establish Moslem prayer in all Western Countries, enforced by law

Establish modest dress in every Moslem Country

Establish pure Islam in all Moslem Countries

Create your own

(This program does not exclude extremist positions. It is not unreasonable to include some interested extremists in collective bargaining. Chances are “moderates” will hold at least some of these views anyway, particularly at the beginning of the process. However everyone will have to be carefully searched before they enter the process.)

I. MODEL WORKSHEETS FOR ISRAELIS:

Israeli specialists to over-see Palestinian arrests of militants

American specialists to over-see Palestinian arrests of militants

Israelis and Palestinians work together to build jails to hold extremists

Palestinians and Israelis work out border agreements if no terrorism has occurred in 8 months

For every year that no terrorism has occurred, Israelis will dismantle and leave an occupied territory

Ariel Sharon will step down if a year has passed without a terrorist attack

For every month where not terrorism has occurred, Israelis will send apologies to families of Palestinians accidentally killed by their military attacks

Israel will continue to build separating wall

If 8 months go buy without another terrorist attack, Israelis will start negotiation of water and sewage rights with Palestinians

Israelis will declare the existence of a Palestinian State after 1 year free of terrorism, and will leave all occupied territories

Israel will accept American non-military supervisors to oversee their leaving occupied territories and will certify this to Palestinians

Israelis will pay for the destruction they did to Palestinian buildings and assist in their reconstruction, with American aid

Israelis will agree to a negotiated number of “terrorist” incidents that might occur within the first year of working on Worksheets without military attacks against Palestinians

Set up Worksheets for Audit inspections, monitoring agreements and creating new ones

Create your own

II. MODEL WORKSHEETS FOR PALESTINIANS

Palestinians will work with Israeli specialists to arrest and imprison militants

Palestinians will disavow the destruction of Israel

Palestinians will have Arafat step down after Israelis pull out of at least one occupied territory

Palestinians will stop asking and receiving military aid and assistance from Hezbollah, Hamas, Iraq and Iran

Palestinians will close radical Islamic Maddrassas in their Country

Palestinians will stop demonstrating in the streets against Israel and Jews

Palestinians will accept non-military American supervisors to oversee their imprisonment of militants

Palestinians will eject Hamas, Hezbollah and Iranian militants from their areas or imprison them

Palestinians will establish a special security “secret” police to monitor militant behavior against their leaders or Israel

Palestinians will elect new moderate leadership after the withdrawal of Israelis from two occupied territories

Palestinians will not permit any activity or hate speech against Israel or Israelis

Palestinians will agree to permit a negotiated number of retributions against Islamic militants without dropping working on the Worksheets within the first year

The families of Palestinian militants whose members' attacked Israel will send letters of apology to the families that were killed in the attacks

Set up Worksheets for Audit inspections, monitoring agreements and creating new ones

Create your own

III. MODEL WORKSHEETS FOR MODERATE ARAB COUNTRIES

They will stop teaching hatred against Jews, Israelis and Americans, and close radical Islamic Maddrassas

They will accept Israel as a state that has a right to exist as soon as the Israelis, Palestinians and Israelis start their Worksheets

They will adopt full diplomatic relations with Israel after 6 months of working on the Worksheets and verification by auditors

Full diplomatic relations means establishing consulate offices between each of the Countries involved

After a year has passed without any terrorist attacks against Israel or the United States, moderate Islamic Countries will establish free trade with Israel

They will close any terrorist training camps and cease supporting terrorism with money or services

They will contact their Islamic neighbors and ask them to stop supporting terrorism against Israel and the United States after the Worksheets are signed by Israelis and Palestinians

Moderate and oil rich Arab Countries will assist the Palestinians in stopping militants from entering the Palestinian State, as well as providing extensive monetary assistance

Set up Worksheets for Audit inspections, monitoring agreements and creating new ones

Oil wealth will be used to pay for this program's auditors and computer professionals

Create your own

IV. MODEL WORKSHEETS FOR THE UNITED STATES

The U.S. will work toward closing their bases in Saudi Arabia, with the goal of having it closed and their leaving a year after Israel recognizes a Palestinian State

America will act as a broker for peace between the Palestinian American journalists will consider their reporting on both Arab and Israeli issues with more discretion and try to avoid either anti-Israel or anti-Arab propaganda.

America will try to stop profiling Arab appearing people

Help all parties set up Worksheets for Auditing

Provide Audit services

Create your own

The purpose for this project is to encourage slow, steady confidence building growth for difficult issues, with knowledge that monitoring is actually negotiated into agreements.. Attitudes can change when there is virtual certainty of monitoring and documentation. For this reason, it is recommended that auditors be present during collective bargaining and help participants execute agreements. There is no limit to the number of participants who can use the program, but it is recommended that large, vexing problems be split into manageable focus groups. Under those circumstances, it is recommended that a Senior Auditor be hired to oversee the statistical evaluations. This is a gigantic program.

Thousands of people could take part in this process, on both sides. I see this as an advantage, not a disadvantage. The process can continue for years as necessary, generating mountains of data which could over a long period of time have a predictive value, as data collection normally does. Even friendly nations have disagreements. But they don't typically result in suicide bombings and war. The psychology of group participation in the peace process has the same enormous potential as the quantity of data that will be generated. It can be published on an Internet site for everyone to see. A paid bureaucracy of auditors can continue far into the successful conclusion, improving the economy and providing well paid jobs for professionals on both sides.

Further bringing this concept into a circle, it will be necessary to place these mountainous data into a larger program for evaluation. The inventor of this program acknowledges that this is necessary and appropriate. The solution to this tragedy does not exist alone in any one concept. If successful, it will depend on the efforts of many people, as it should. As new problems inevitably occur, they are installed into preference selection→collective bargaining→consensus→performance→data collection and evaluation→audit→re-audit of performance→new preference selection, etc. The program is always operating with the installation of new problems to solve and proof that old problems are constantly being worked on, all of which are progressing through the same circle: A new approach to very old problems.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for non-linear negotiation for one or more users comprising:
an input subsystem for one or more users to input and store preferences;
a non-user auditor;
inputting and storing for each user relational attributes of each preference and agreed upon by all users and the auditor;
a list for each user of the preferences and each preference's relational attribute, and
a compliance subsystem for users to indicate whether each preference is completed not completed, or the degree to which it is partially completed on an ongoing basis;
whereby the auditor monitors progress of list preferences and can interact with each user as needed.

2. A system as claimed in claim 1 wherein negotiation and behavior modification skills are explained and illustrated.

3. A system as claimed in claim 1 wherein preferences may be tasks or data.

4. A system as claimed in claim 1 wherein the relational attribute for one or more preferences may have mathematical features attached.

5. A system as claimed in claim 1 wherein the relational attribute for all created lists may be hierarchical.

6. The system as claimed in claim 1 further comprising statistical reports based on the users' preferences, the preferences' relational attributes, and state of completion of the preferences.

7. A system as claimed in 1 that allows one or more of the users and auditor to exchange roles or functions with one or more other users or auditor.

8. A method for non-linear negotiation, behavioral modification, and or data manipulation for users comprising the steps of:
creating a list of preferences for each user, or data stream for each user;
creating lists of preferences and/or a data stream and assigning user designated values to entries;
establishing a non-user auditor;
agreement by all users and auditor on relational attributes for each preference or entry from the data stream;
indicating for each user whether each preference or item in data stream is evaluated or completed, not evaluated or completed, or the degree to which the preference or data stream items are partially completed on an ongoing basis; and
creating detailed reports based upon the user's pre-designated algorithms or mathematical choices;
monitoring progress of list preference by the auditor and interacting with any user on an as needed basis.

9. The method as claimed in 8 further comprising the step of viewing negotiation identification, behavior modification and various instruction forms from a Report Printing Module.

10. The method as claimed in 8 further comprising the step of generating a statistical report based upon the users' preferences, the preferences relational attributes and state of completion of the preferences.

11. The method as claimed in 9 wherein the statistical report uses an algorithm of the users' designated construct.

12. The method as claimed in 8 wherein the operation is passed through the following discrete and interconnected modules, Licensing and Disclaimers, Data Base Module, Screen identified as What do you want?, Sub Choice Categories, Open File Name, Value Assignment Module, List Items in Order from Most important at top, to least at Bottom, Work Sheet Creation Module, Load to PDA, Upload finished Worksheets back into Central Computer, Hand Entry, Report Module, Auditor's Registration Module, Auditor's Prepare Their Own Worksheets for Audit, Auditor's Enter prepared Worksheets Files for Auditing Completion, Auditor's Printed Reports.

13. The method as claimed in 8 further comprising is a continuous feedback loop for Auditors and all users.

14. The method as claimed in 8 which allows a single user and Auditor to take part in operations of the method, allowing the method to be described as non-linear as long as auditing functions continue unabated.

15. A system for linear negotiation for one or more users comprising:
subsystem for one or more users to input and store preferences;
inputting and storing for each user relational attributes of each preference agreed upon by all users;
a list for each user of the preferences and each preference's relational attribute, and
a subsystem for users to indicate whether each preference is completed not completed, or the degree to which it is partially completed on an ongoing basis.

16. A system as claimed in claim 15 wherein negotiation and behavior modification skills are explained and illustrated.

17. A system as claimed in claim 15 wherein preferences may be tasks or data.

18. A system as claimed in claim 15 wherein the relational attribute for one or more preferences may have mathematical features attached.

19. A system as claimed in claim 15 wherein the relational attribute for all created lists may be hierarchical.

20. The system as claimed in claim 15 further comprising statistical reports based on the users' preferences, the preferences' relational attributes, and state of completion of the preferences.
